(19) United States
(12) Patent Application Publication
(10) Pub. No.: US 2011/0257284 A1
(43) Pub. Date: Oct. 20, 2011

(54) PROCESS FOR PRODUCING FLAME-RETARDANT PU FOAMS

(75) Inventors: Bernd BRUCHMANN, Freinsheim (DE); Daniel SCHONFELDER, Bruxelles (BE); Jens FERBITZ, Osnabrueck (DE); Andrea EISENHARDT, Vechta (DE); Maxim PERETOLCHIN, Mannheim (DE)

(73) Assignee: BASF SE, Ludwigshafen (DE)

(21) Appl. No.: 13/084,753

(22) Filed: Apr. 12, 2011

Related U.S. Application Data
(60) Provisional application No. 61/324,328, filed on Apr. 15, 2010.

(51) Int. Cl. C08J 9/04; C08G 18/64; C08G 18/50

(52) U.S. Cl. 521/137

(57) ABSTRACT

The present invention describes a process for producing flame-retardant polyurethane foams. The process of the invention includes the use of hyperbranched, nitrogen-containing polymers for providing flame retardancy to polyurethane foams. The amounts used of the hyperbranched compounds are preferably from 5 to 20% by weight, based on the polyol component. The N content of preferred nitrogen-containing compounds is at least 2% by weight. The N content of the polyurethane foams of the invention is from 1 to 8% by weight from the hyperbranched polymer. Compounds in particular used are hyper-branched polyureas, hyperbranched polyamides, and in particular hyperbranched polylysines, hyperbranched polyisocyanurates, and hyperbranched polyesteramides.

An advantage of the use of the compounds of the invention is that the polyurethane foams can be rendered flame-retardant without the use of, or by using markedly reduced amounts of, halogen-containing flame retardants. It is likewise possible to achieve a marked reduction in, or to avoid, the use of additive, halogen-free flame retardants. The processing profile and the mechanical properties of the polyurethane foams are thus significantly improved. The compounds of the invention are preferably used in such a way that the foams are rendered flame-retardant without use of halogen.

The hyperbranched polymers of the invention can provide flame retardancy either to flexible polyurethane foam or to rigid polyurethane foam.

The invention relates to a process for producing flame-retardant polyurethane foams, and also to the use of nitrogen-containing hyperbranched polymers as flame-retardant component in polyurethane foams.

Polyurethane foams have been known for a long time and are widely described in the literature. They are usually produced via reaction of polyisocyanates with compounds having at least two hydrogen atoms reactive toward isocyanate groups, these compounds mostly being polyols. Polyurethane foams are used in many sectors. Important examples are mattresses, furniture, automobile seats, transport, construction, and technical insulation.

The underlying units of which polyurethane foams are composed are organic, and the foams are therefore in principle combustible. In order to minimize any possible fire risk, flame retardants can be used in the polyurethane foams. Said flame retardants in particular inhibit the spread of fire during the initial phase of a fire. Polyurethane foams used as insulating materials in the construction sector have to be flame-retardant. Various countries have created specifications and regulations in order to ensure that the insulation materials used have a particular flame retardancy in accordance with a defined test method.

In the flexible polyurethane foams sector, producers are subject to increasing pressure to render these foams flame-retardant. In the sector of furniture applications, safety requirements have become ever more stringent, and this trend is expected to continue. Quite a few countries have national regulations for the provision of flame retardancy to flexible polyurethane foams. The state of California in the USA, for example, has implemented a criterion for increased flame retardancy with the title California Technical Bulletin No 117, which has become established as requirement for flexible furniture foams in the USA.

The flame retardants usually used are organic compounds comprising heteroatoms, in particular comprising halogens or comprising phosphorus.

Halogenated flame retardants are widely used in flexible polyurethane foam. Bromine-comprising compounds are generally no longer used, for reasons of toxicology, and have frequently been replaced by chlorinated compounds; TCPP (tris(2-chloropropyl)phosphate) is therefore a flame retardant widely used in flexible polyurethane foam.

Rigid polyurethane foam uses both chlorinated and brominated compounds. However, the halogenated compounds, and in particular the brominated compounds, and especially here the aromatic brominated compounds, have recently been subject to criticism. They are generally toxic, and they accumulate both in the environment and in living organisms. It is therefore likely that polyurethane foam producers will be subject to increasing pressure to use halogen-free flame retardants.

Another disadvantage of the halogen-containing flame retardants is the formation of toxic gases in the event of a fire. They also liberate halogen acids, and when the materials are used as insulation these acids cause additional damage to the fabric of buildings in the event of a fire. Here again, it is advantageous to use halogen-free flame retardants.

Organic esters of phosphoric acid and of phosphonic acid are effective halogen-free flame retardants. Said compounds preferably comprise no groups which can react with the polyisocyanates and via which they can become incorporated into the polyurethane skeleton; they are therefore classified within the group of what are known as additive flame retardants.

Flame retardants of this type have a markedly adverse effect on the mechanical properties of the flame-retardant foams. Low-molecular-weight additive flame retardants, e.g. triethyl phosphate (TEP), act as plasticizers and thus adversely affect hardness and other service properties of the foams. They also contribute to the emissions from the foams.

There are many flame retardants which participate in the polyisocyanate-polyaddition reaction by virtue of functional groups which they comprise. Exolit OP560 is one example. These flame retardants are incorporated into the polyurethane foam and therefore make no contribution to emissions. However, the functionality of these compounds is from 1 to 2, therefore being lower than the average functionality of the other reactive H-acid compounds. This leads to a markedly adverse effect on the mechanical properties of the foams, since the crosslinking density achieved is lower than in the corresponding non-flame-retardant foam.

There is currently no known reactive flame retardant that has no effect on processing and foam properties and that simultaneously has high effectiveness as flame retardant.

Melamine is used in flexible polyurethane foam to produce foams with high flame retardancy. This nitrogen-containing solid increases flame retardancy inter alia via liberation of ammonia at high temperatures. However, the use of melamine is attended by marked disadvantages during processing. The material is an insoluble solid, and operations therefore have to be carried out under particular conditions in order to ensure uniform dispersion of the melamine within the polyol component. Alongside this sedimentation behavior, there is also a tendency of melamine to cause abrasion on the machinery used. If melamine is incorporated into the structure of a polyol, so that it is easier to process and becomes incorporated into the main polymer chain, its flame-retardant action is significantly reduced.

It would therefore be advantageous to transfer the flame-retardant action brought about by way of the melamine nitrogen to compounds which are liquid, reactive, and easy to process. These compounds should moreover be halogen-free, for the abovementioned reasons.

Production of flame-retardant rigid polyurethane foams mostly uses not only additive flame retardants comprising phosphorus but also reactive flame retardants comprising bromine or comprising chlorine. When partially halogenated hydrocarbons, known as HCFCs and HFCs, are used as blowing agents in order to comply with the fire standards demanded in the construction industry, for example construction materials classification B2 in accordance with DIN 4102, or Epiradiateur classification M1 or M2, the proportion of flame retardants is from 40 to 45% by weight of the polyol component. The proportions of the additive flame retardants comprising phosphorus as a ratio to the proportions of the reactive, halogen-containing flame retardants here were about 50:50 parts by weight.

With introduction of the blowing agent pentane, which is compatible with the environment, but combustible, the proportions of flame retardant in the polyol component had to be increased to from 55 to 60% by weight, and the proportion of the halogenated flame retardants here has generally risen to a greater extent.

The use of such large amounts of flame retardant is attended by marked disadvantages.

It is naturally not acceptable that the flame retardancy requirements cause impairment of mechanical properties. Replacement of the reactive flame retardants comprising bromine by additive flame retardants comprising phosphorus in rigid polyurethane foam cannot be achieved with retention of the required mechanical and thermal properties.

The additive flame retardants comprising phosphorus in particular act as plasticizers, which have a markedly adverse effect on the properties determined for the foams, an example being heat resistance or deformation under prolonged load. The reactive compounds comprising bromine are generally of low functionality and provide only a small contribution to the three-dimensional crosslinking required in the case of rigid foams. This means that the flame retardants comprising bromine also impair the level of particular mechanical and thermal properties of flame-retardant rigid polyurethane foams.

In order to improve environmental compatibility and to increase the level of properties of rigid polyurethane foams, it is therefore necessary to achieve a marked reduction in the proportions of flame retardant, but this has to be achieved without impairing flame retardancy.

There are various ways of reducing the proportions of flame retardant. In particular, a reduction in the proportions of flame retardant can be achieved via incorporation of specific structures into the rigid polyurethane foams. Advantageous results are in particular obtained via the incorporation of isocyanurate groups into the polyurethane foams.

A disadvantage of these foams modified by isocyanurate groups, also often termed PIR foams, is their relatively high brittleness. A particular result of this is impairment of the adhesion of the foams to outer layers applied by foaming processes. The problem of the adhesion of PIR foams has not so far been solved, and there are therefore some sectors in which PIR foams cannot be used.

The present invention is therefore based on the object of providing flame-retardant polyurethane foams which comprise no, or a markedly reduced amount of, chlorine-containing flame retardants and/or additive phosphorus-containing flame retardants. The polyurethane foams of the invention never comprise any bromine-containing flame retardants, and preferably also never comprise any other halogen-containing flame retardants. The content of conventional non-halogenated, additive flame retardants in the polyol component should preferably be 0% by weight, but at least be less than 30% by weight, based on the polyol component. The term polyol component means the mixture made of the compounds reactive toward isocyanates with the blowing agents, flame retardants, catalysts, auxiliaries, and/or additives.

The foams obtained should not have the disadvantages of the flame-retardant foams of the prior art, impairment of adhesion, and impairment of mechanical properties. In particular, it should also be possible to produce flame-retardant PU foams without use of halogen-containing flame retardants.

The object is achieved via a process for producing polyurethane foams, by mixing (a) polyisocyanates with (b) a compound having at least two reactive hydrogen atoms, (c) nitrogen-containing hyperbranched polymers having at least 2% by weight nitrogen content, (d) optionally low-molecular-weight chain extenders and/or crosslinking agents, (e) catalysts, (f) blowing agents, and (g) optionally additives, to give a reaction mixture, and hardening to give the polyurethane foam, and also via the polyurethane foams themselves.

Surprisingly, it has been found that nitrogen-containing hyperbranched polymers exhibit a flame-retardant effect. Foams comprising monomeric compounds bearing urea groups, e.g. dimethylurea, do not pass a fire test. Urea and melamine are insoluble in polyols and are therefore attended by problems during processing. In contrast to melamine, however, the flame-retardant action of urea is increased via incorporation into an oligomeric or polymeric structure reactive toward isocyanates. This minimizes the effect on the mechanical properties of the foam while simultaneously improving proccessability and fire-test effectiveness. The person skilled in the art would not have expected this.

The nitrogen-containing hyperbranched compounds of the invention generally comprise at least 3% by weight and at most 75% by weight, preferably at least 5% by weight and at most 50% by weight, particularly preferably at least 9% by weight and at most 35% by weight, with particular preference at least 9% by weight and at most 30% by weight, of nitrogen. The polyurethane foam of the invention generally comprises at least 1% by weight, preferably at least 3% by weight, of nitrogen, and at most 18% by weight, preferably at most 15% by weight, of nitrogen, where this derives from the hyperbranched polymer.

Polyurethane foams obtainable by the process of the invention are rigid polyurethane foams and flexible polyurethane foams.

Rigid Polyurethane Foams

Preferred compounds (b) used having at least two hydrogen atoms reactive toward isocyanate are polyalcohols (b1), in particular polyether alcohols and/or polyester alcohols, where these have OH numbers in the range from 100 to 1200 mg of KOH/g.

Polyether alcohols (b1) for rigid polyurethane foams are produced via reaction of low-molecular-weight polyfunctional alcohols or amines with alkylene oxides, and it is preferable here to use propylene oxide as alkylene oxide. However, the reaction can also be carried out with mixtures made of propylene oxide and of another alkylene oxide, preferably ethylene oxide. The low-molecular-weight alcohols used preferably comprise diols to octaols, examples being ethylene glycol, propylene glycol, glycerol, trimethylolpropane, pentaerythritol, sorbitol, and/or sugars.

The polyether alcohols (b1) used preferably comprise polyethylene glycols having molar masses in the range from 100 to 2000 g/mol, in particular in the range from 200 to 1500 g/mol.

The isocyanate index preferably used in carrying out the process of the invention is in the range from 100 to 220. Indices in the range from 120 to 180 are preferred for producing foams with good mechanical and thermal properties. The term isocyanate index means the ratio of isocyanate groups to reactive hydrogen atoms in the reaction mixture. Indices above 180, for example 250, 300 or 500, are required only for producing PIR foams.

The mixing ratio (ratio by weight) of polyol component (b) to the polyisocyanate (a) here is preferably in the range from 100:140 to 100:200.

The following details relate to the starting compounds used for the process of the invention:

Organic polyisocyanates (a) that can be used preferably comprise aromatic polyfunctional isocyanates.

Detailed examples that may be mentioned are: tolylene 2,4- and 2,6-diisocyanate (TDI) and the corresponding isomer mixtures, diphenylmethane 4,4′-, 2,4′-, and 2,2′-diisocyanate (MDI) and the corresponding isomer mixtures, mixtures made of diphenylmethane 4,4′- and 2,4′-diisocyanates, polyphenyl polymethylene polyisocyanates, mixtures made of diphenylmethane 4,4′-, 2,4′-, and 2,2′-diisocyanates and of polyphenyl polymethylene polyisocyanates (crude MDI or PMDI), and mixtures made of crude MDI/PMDI and of tolylene diisocyanates. The organic di- and polyisocyanates can be used individually or in the form of mixtures.

Other compounds also frequently used are those known as modified polyfunctional isocyanates, i.e. products which are obtained via chemical reaction of organic di- and/or polyisocyanates. Examples that may be mentioned are di- and/or polyisocyanates comprising isocyanurate groups, comprising uretdione groups, comprising allophanate groups, comprising carbodiimide groups, and/or comprising urethane groups. The modified polyisocyanates can optionally be mixed with one another or with unmodified organic polyisocyanates, e.g. diphenylmethane 2,4′- and 4,4′-diisocyanate, crude MDI/PMDI, and tolylene 2,4- and/or 2,6-diisocyanate.

Other compounds that can also be used alongside these are reaction products of polyfunctional isocyanates with polyfunctional polyols, and also mixtures of these with other di- and polyisocyanates.

A compound which has proven particularly successful as organic polyisocyanate is PMDI with from 29 to 33% by weight NCO content and with viscosity in the range from 100 to 1000 mPas at 25° C.

Particular compounds (b) which can be used together with the polyether alcohols (b1), and which have at least two hydrogen atoms reactive toward isocyanate are polyether alcohols and/or polyester alcohols, where these have OH numbers in the range from 100 to 1200 mg of KOH/g.

The polyester alcohols used together with the polyether alcohols (b1) are mostly produced via condensation of polyfunctional alcohols, preferably diols, having from 2 to 12 carbon atoms, preferably from 2 to 6 carbon atoms, with polyfunctional carboxylic acids having from 2 to 12 carbon atoms, examples being succinic acid, glutaric acid, adipic acid, suberic acid, azelaic acid, sebacic acid, decanedicarboxylic acid, maleic acid, fumaric acid, and preferably phthalic acid, isophthalic acid, terephthalic acid, and the isomeric naphthalenedicarboxylic acids.

The polyester alcohols used together with the polyether alcohols (b1) mostly have functionality of from 2 to 8, in particular from 3 to 6.

Compounds particularly used are polyether polyols, where these are produced by known processes, for example via anionic polymerization of alkylene oxides in the presence of catalysts, preferably alkali metal hydroxides.

Alkylene oxides mostly used comprise ethylene oxide and/or propylene oxide, preferably pure propylene 1,2-oxide.

Particular starter molecules that are used are compounds having at least 2, preferably from 3 to 8, hydroxy groups, or having at least two primary amino groups, within the molecule.

Preferred starter molecules which are used and which have at least 2, preferably from 3 to 8, hydroxy groups within the molecule are ethylene glycol, propylene glycol, trimethylolpropane, glycerol, pentaerythritol, sugar compounds, such as glucose, sorbitol, mannitol, and sucrose, polyfunctional phenols, resols, e.g. oligomeric condensates made of phenol and formaldehyde, and Mannich condensates made of phenols, of formaldehyde, and of dialkanolamines, and also melamine.

Preferred starter molecules which are used and which have at least two primary amino groups in the molecule are aromatic di- and/or polyamines, examples being phenylenediamines, 2,3-, 2,4-, 3,4-, and 2,6-tolylenediamine, and 4,4′-, 2,4′-, and 2,2′-diaminodiphenylmethane, and also aliphatic di- and polyamines, such as ethylenediamine.

The functionality of the polyether polyols is preferably from 3 to 8, and their hydroxy numbers are preferably from 100 mg of KOH/g to 1200 mg of KOH/g, and in particular from 200 mg of KOH/g to 570 mg of KOH/g.

Among the compounds (b) having at least two hydrogen atoms reactive toward isocyanate are also the crosslinking agents and chain extenders which are optionally used concomitantly. The addition of difunctional chain extenders, crosslinking agents of functionality three and higher, and optionally a mixture thereof, can prove advantageous for modifying mechanical properties. Chain extenders and/or crosslinking agents used in particular comprise diols, triols, and/or alkanolamines, where these have molecular weights smaller than 400, preferably from 60 to 300.

The amount used of chain extenders, crosslinking agents, or mixtures of these is usefully from 1 to 20% by weight, preferably from 2 to 5% by weight, based on polyol component (b).

Further information relating to the polyether alcohols and polyester alcohols used, and also to the production of these, can be found by way of example in Kunststoffhandbuch [Plastics handbook], volume 7 “Polyurethane” [Polyurethanes], edited by Günter Oertel, Carl-Hanser-Verlag, Munich, 3rd edition, 1993.

Flexible Polyurethane Foams

For the purposes of the invention, flexible polyurethane foams are polyisocyanate-polyaddition products which are foams in accordance with DIN 7726 and which exhibit a compressive stress value at 10% compression or, respectively, compressive strength in accordance with DIN 53 421/DIN EN ISO 604 of 15 kPa or less, preferably from 1 to 14 kPa, and in particular from 2 to 14 kPa. The open-cell factor in accordance with DIN ISO 4590 of flexible polyurethane foams for the purposes of the invention is preferably greater than 85%, particularly preferably greater than 90%.

Polyisocyanate component (a) used to produce the flexible polyurethane foams of the invention comprises any of the polyisocyanates known for producing polyurethanes. These comprise the aliphatic, cycloaliphatic, and aromatic di- or polyfunctional isocyanates known from the prior art, and also any desired mixtures thereof. Examples are diphenylmethane 2,2′-, 2,4′-, and 4,4′-diisocyanate, the mixtures made of monomeric diphenylmethane diisocyanates and of diphenylmethane diisocyanate homologs having a larger number of rings (polymer MDI), isophorone diisocyanate (IPDI) or its oligomers, tolylene 2,4- or 2,6-diisocyanate (TDI) or mixtures of these, tetramethylene diisocyanate or its oligomers, hexamethylene diisocyanate (HDI) or its oligomers, naphthylene diisocyanate (NDI), and mixtures thereof.

It is preferable to use diphenylmethane 2,2′-, 2,4′-, and 4,4′-diisocyanate, the mixtures made of monomeric diphenylmethane diisocyanates and of diphenylmethane diisocyanate homologs having a larger number of rings (polymer MDI), tolylene 2,4- or 2,6-diisocyanate (TDI), or mixtures of these, isophorone diisocyanate (IPDI) or its oligomers, hexamethylene diisocyanate (HDI) or its oligomers, or a mixture made of the isocyanates mentioned. The isocyanates preferred for use can also comprise uretdione groups, allophanate groups, uretonimine groups, urea groups, biuret groups, isocyanurate groups, or iminooxadiazinetrione groups. Other possible isocyanates are given as examples in “Kunststoffhandbuch, Band 7, Polyurethane” [Plastics handbook, volume 7, Polyurethanes], Carl Hanser Verlag, 3rd edition 1993, chapter 3.2 and 3.3.2.

Alternatively, the polyisocyanate (a) is used in the form of polyisocyanate prepolymers. These polyisocyanate prepolymers are obtainable by reacting polyisocyanates (a-1) described above with polyols (a-2), for example at temperatures of from 30 to 100° C., preferably at about 80° C., to give the prepolymer. Compounds preferably used for producing the prepolymers of the invention are polyols based on polyethers, for example using ethylene oxide and/or propylene oxide as starting material, or polyesters, for example using adipic acid as starting material.

Polyols (a-2) are known to the person skilled in the art and are described by way of example in “Kunststoffhandbuch, 7, Polyurethane” [Plastics handbook, 7, Polyurethanes], Carl Hanser Verlag, 3rd edition 1993, chapter 3.1. Polyols (a-2) preferably used are relatively high-molecular-weight compounds having at least two reactive hydrogen atoms as described under (b).

In one embodiment, the prepolymer can be produced by using, as constituent (a-2), a hyperbranched polyether having hydrogen atoms reactive toward isocyanates.

It is also optionally possible to add chain extenders (a-3) to the reaction to give the polyisocyanate prepolymer. Suitable chain extenders (a-3) for the prepolymer are di- or trifunctional alcohols, for example dipropylene glycol and/or tripropylene glycol, or the adducts of dipropylene glycol and/or tripropylene glycol with alkylene oxides, preferably propylene oxide.

The relatively high-molecular-weight compound (b) which is used and which has at least two reactive hydrogen atoms is any of the compounds that are known and conventional for producing flexible polyurethane foams.

The compound (b) having at least two active hydrogen atoms preferably comprises polyether alcohols and/or polyester alcohols having a functionality of from 2 to 8, in particular from 2 to 6, preferably from 2 to 4, and having average equivalent molar mass in the range from 400 to 5000 g/mol, preferably from 1000 to 2500 g/mol.

The polyether alcohols can be produced by known processes, mostly via a catalytic addition reaction of alkylene oxides, in particular ethylene oxide and/or propylene oxide, onto H-functional starter substances, or via condensation of tetrahydrofuran. Particular H-functional starter substances that are used are polyfunctional alcohols and/or amines. It is preferable to use water, difunctional alcohols, such as ethylene glycol, propylene glycol, or butanediols, trifunctional alcohols, such as glycerol or trimethylolpropane, or else polyfunctional alcohols, such as pentaerythritol, or sugar alcohols, such as sucrose, glucose, or sorbitol. Amines preferably used are aliphatic amines having up to 10 carbon atoms, for example ethylenediamine, diethylenetriamine, and propylenediamine, or else aminoalcohols, such as ethanolamine or diethanolamine. Alkylene oxides used preferably comprise ethylene oxide and/or propylene oxide. Particular catalysts used in the addition reaction of the alkylene oxides are basic compounds, and potassium hydroxide is the most important compound used industrially here. If the intention is that content of unsaturated constituents in the polyether alcohols be small, other catalysts that can be used are di- or multimetal cyanide compounds, known as DMC catalysts. It is also possible to use, in component (b), the polyether alcohol used for producing the prepolymer.

Production of flexible polyurethane foams in particular uses di- and/or trifunctional polyether alcohols.

The compound used having at least two active hydrogen atoms can also comprise polyester polyols, which by way of example can be produced from organic dicarboxylic acids having from 2 to 12 carbon atoms, preferably from aliphatic dicarboxylic acids having from 8 to 12 carbon atoms, and from polyfunctional alcohols, preferably diols, having from 2 to 12 carbon atoms, preferably from 2 to 6 carbon atoms. Examples of dicarboxylic acids that can be used are: succinic acid, glutaric acid, adipic acid, suberic acid, azelaic acid, sebacic acid, decanedicarboxylic acid, maleic acid, fumaric acid, phthalic acid, isophthalic acid, terephthalic acid, and the isomeric naphthalenedicarboxylic acids. It is preferable to use adipic acid. The dicarboxylic acids here can be used either individually or else in a mixture with one another. It is also possible, instead of the free dicarboxylic acids, to use the corresponding dicarboxylic acid derivatives, e.g. dicarboxylic esters of alcohols having from 1 to 4 carbon atoms, or dicarboxylic anhydrides.

Examples of di- and polyfunctional alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol, and trimethylolpropane. It is preferable to use ethanediol, diethylene glycol, 1,4-butanediol, 1,5-pentanediol, 1,6-hexanediol, or a mixture made of at least two of the diols mentioned, in particular a mixture made of 1,4-butanediol, 1,5-pentanediol, and 1,6-hexanediol. Other compounds that can be used are polyester polyols made of lactones, e.g. ε-caprolactone, or hydroxycarboxylic acids, e.g. ω-hydroxycaproic acid, and hydroxybenzoic acids. It is preferable to use dipropylene glycol.

The hydroxy number of the polyester alcohols is preferably in the range from 30 to 100 mg of KOH/g.

Other suitable polyols are polymer-modified polyols, preferably polymer-modified polyesterols or polyetherols, particularly preferably graft polyetherols or graft polyesterols, in particular graft polyetherols. A polymer-modified polyol is what is known as a polymer polyol, where this usually has 5 to 60% by weight, preferably from 10 to 55% by weight, particularly preferably from 30 to 55% by weight, and in particular from 40 to 50% by weight, content of preferably thermoplastic polymers.

Polymer polyols are described by way of example in EP-A-250 351, DE 111 394, U.S. Pat. No. 3,304,273, U.S. Pat. No. 3,383,351, U.S. Pat. No. 3,523,093, DE 1 152 536, and DE 1 152 537, and are usually produced via free-radical polymerization of suitable olefinic monomers, for example styrene, acrylonitrile, (meth)acrylates, (meth)acrylic acid, and/or acrylamide, in a polyol serving as graft base, preferably polyesterol or polyetherol. The side chains are generally produced via transfer of the free radicals from growing polymer chains to polyols. The polymer polyol comprises, alongside the graft copolymers, mainly the homopolymers of the olefins, dispersed in unaltered polyol.

In one preferred embodiment, monomers used comprise acrylonitrile and styrene. The monomers are polymerized optionally in the presence of other monomers, of a macromer, or of a moderator, and with use of a free-radical initiator, mostly azo compounds or peroxide compounds, in a polyesterol or polyetherol as continuous phase.

If polymer polyol is comprised within the relatively high-molecular-weight compound (b), this is preferably present together with other polyols, for example with polyetherols, or with polyesterols, or a mixture made of polyetherols and of polyesterols. It is particularly preferable that the proportion of polymer polyol is greater than 5% by weight, based on the total weight of component (b). The amount comprised of the polymer polyols can by way of example, based on the total weight of component (b), be from 7 to 90% by weight, or from 11 to 80% by weight. It is particularly preferable that the polymer polyol is polymer polyesterol or polymer polyetherol.

Nitrogen-Containing Hyperbranched Polymers

Suitable nitrogen-containing hyperbranched polymers (c) are polyureas, polyamides, polythioureas, polyguanidines, polyisocyanurates, polycyanurates, and also all of the mixed forms, such as polyamidoureas and polyamidothioureas, polyurea(thiourea)s, polyesterureas, and polyesterthioureas, polyaminoureas, and polyaminothioureas, polycarbonateureas, and polycarbonatethioureas, polyetherureas, and polyetherthioureas, polyamidoesters, polyamidoamines, polyamidocarbonates, polyamidoethers, polyesteramides, and polyamidocarbonates, as long as these have at least 2% by weight nitrogen content. Particularly preferred nitrogen-containing hyperbranched polymers used here are polyureas, polythioureas, polyamides, polyisocyanurates, and polyesteramides, in particular polyureas, polyisocyanurates, polyamides, and, among the polyamides, particularly preferably polylysines. These polymers, and processes for their production, are described by way of example in EP 1141083, in DE 102 11 664, in WO 2000/56802, in WO 2003/062306, in WO 1996/19537, in WO 2003/54204, in WO 2003/93343, in WO 2005/037893, in WO 2004/020503, in DE 10 2004 026 904, in WO 1999/16810, in WO 2005/026234, in WO 2005/075541, in WO 2005/044897, in WO 2003/006702, and DE 10 2005 056 592, and in the document entitled “Herstellung and Verwendung von hochfunktionellen, hoch-oder hyperverzweigten Polylysinen” [Production and use of high-functionality, highly branched or hyperbranched polylysines].

Hyperbranched polymers suitable for the inventive use, and processes for their production are described by way of example in the following documents, the entire content of which is hereby incorporated herein by way of reference:
hyperbranched polymers containing nitrogen atoms (specifically polyureas, polyamides, poly(esteramides), and poly(esteramines)), as described in WO 2006/087227;
hyperbranched polyureas as described in WO 03/066702, WO 2005/044897, and WO 2005/075541;
hyperbranched polyguanidines in accordance with WO 2009/080787;
hyperbranched poly(esteramides) in accordance with WO 99/16810;
hyperbranched polyamides as described in WO 2006/018125;
hyperbranched nitrogen-containing polymers as described in WO 2009/150090; and
hyperbranched nitrogen-containing polymers comprising polyisocyanurate groups, as described in U.S. Pat. No. 3,293,224.

For the purposes of the present invention, the term “hyperbranched polymers” comprises in very general terms polymers which feature a branched structure and high functionality. For the general definition of hyperbranched polymers, reference is also made to P. J. Flory, J. Am. Chem. Soc. 1952, 74, 2718 and H. Frey et al., Chem. Eur. J. 2000, 6, No. 14, 2499. For the purposes of the invention, the term “hyperbranched polymers” covers dendrimers and high-molecular-weight polymers different therefrom, e.g. comb polymers. “Dendrimers” (hyperbranched polymers, cascade polymers, arborols (dendrimers having hydroxy groups), isotropically branched polymers, isobranched polymers, starburst polymers) are macromolecules which have molecular uniformity and have highly symmetrical structure. Structurally, dendrimers derive from star polymers, where the individual chains respectively in turn have branching in the form of a star. They are produced by starting from small molecules, via a reaction sequence that is constantly repeated, where the number of resultant branching points becomes ever higher, and at the ends of the branching points there are respectively functional groups which in turn are a starting point for further branching points. The number of monomer end groups therefore rises exponentially with each reaction step, finally producing a spherical, tree-like structure. A characteristic feature of dendrimers is the number of reaction stages (generations) carried out to form their structure. The uniform structure of dendrimers generally gives them a defined molar mass.

Preferred suitable compounds are hyperbranched polymers which have both molecular and structural nonuniformity, having side chains of different length and branching, and also having a molar mass distribution.

Particularly suitable compounds for synthesizing these hyperbranched polymers are those known as ABₓ monomers. These have two different functional groups A and B which can react with one another to form a linkage. Each molecule here comprises only one of the functional group A, while comprising two or more of the functional group B. The reaction of said ABₓ monomers with one another produces polymers that are in essence uncrosslinked, having regularly arranged branching points. The chain ends of the polymers have almost exclusively B groups. Further details are available by way of example in Journal of Molecular Science, Rev. Macromol. Chem. Phys., C37(3), 555-579 (1997).

The degree of branching (DB) of the nitrogen-containing hyperbranched polymers used in the invention is preferably from 10 to 100%, with preference from 10 to 90%, and in particular from 20 to 80%.

The degree of branching DB is defined here as

DB [%]=100·(T+Z)/(T+Z+L)

where T is the average number of terminal monomer units, Z is the average number of branched monomer units, and L is the average number of linear monomer units, in each case per molecule of polymeric compound (c) or, respectively, polymer (c). Reference may be made to H. Frey et al., Acta Polym. 1997, 48, 30 for the definition of DB.

It is preferable to use hyperbranched polymers, i.e. polymers having molecular and structural nonuniformity. Production of these is generally simpler and therefore more cost-effective than that of dendrimers. However, it is also possible, of course, to use dendrimeric polymers which have structural and molecular uniformity in order to achieve advantageous surface-modification.

It is preferable that the hyperbranched polymers (c) containing nitrogen atoms have been selected from polyisocyanurates, polyureas, polyamides, and mixtures thereof.

It is preferable that the hyperbranched polymers used in the invention have at least four further functional groups, alongside the groups resulting from the synthesis of the hyperbranched structure (e.g. in the case of hyperbranched polyureas, urea groups; in the case of hyperbranched polyamides, amide groups, etc.). The maximum number of said functional groups is generally not critical. However, it is often not more than 100. It is preferable that the number of functional groups is from 4 to 100, specifically from 5 to 30, and more specifically from 6 to 20.

Preference is given to polymers whose weight-average molecular weight is in the range of about 500 to 100 000, preferably 750 to 50 000, in particular 1000 to 30 000.

For the purposes of the present invention, the term alkyl comprises straight-chain and branched alkyl groups. Examples of suitable short-chain alkyl groups are straight-chain or branched C₁-C₇-alkyl, preferably C₁-C₆-alkyl, and particularly preferably C₁-C₄-alkyl groups. Among these are in particular methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, octyl, etc.

For the purposes of the present invention, the term “alkylene” means straight-chain or branched alkanediyl groups having from 1 to 4 carbon atoms, e.g. methylene, 1,2-ethylene, 1,3-propylene, etc.

Cycloalkyl is preferably C₅-C₈-cycloalkyl, such as cyclopentyl, cyclohexyl, cycloheptyl, or cyclooctyl.

Aryl comprises unsubstituted and substituted aryl groups and is preferably phenyl, tolyl, xylyl, mesityl, naphthyl, fluorenyl, anthracenyl, phenanthrenyl, naphthacenyl and in particular phenyl, tolyl, xylyl, or mesityl.

Hyperbranched Polyureas

In an advantageous method for producing polyurea, one or more ureas is/are reacted with one or more amines having at least two primary and/or secondary amino groups, where at least one amine has three primary and/or secondary amino groups (WO 2005/075541). Lines 3 to 37 on page 4 of WO 2005/075541 describe particularly suitable ureas; page 4, line 39 to page 6, line 20 describe particularly suitable amines. Page 6, line 22 to page 7, line 17 of WO 2005/075541 describe the preferred reaction of the ureas with the di- or polyamine.

Suitable ureas are urea, and also aliphatically, aromatically, or mixed aliphatically-aromatically substituted ureas, preference being given to urea, thiourea, or aliphatically substituted ureas or thioureas having linear, branched, or cyclic C₁-C₁₂-alkyl radicals. Examples are ethyleneurea, 1,2- or 1,3-propyleneurea, N,N′-diphenylurea, N,N′-ditolylurea, N,N′-dinaphthylurea, N-methyl-N′-phenylurea, N-ethyl-N′-phenylurea, N,N′-dibenzylurea, N,N′-dimethylurea, N,N′-diethylurea, N,N′-dipropylurea, N,N′-dibutylurea, N,N′-diisobutylurea, N,N′-dipentylurea, N,N′-dihexylurea, N,N′-diheptylurea, N,N′-dioctylurea, N,N′-didecylurea, N,N′-didodecylurea, carbonylbiscaprolactam, ethylenethiourea, propylenethiourea, N-methylthiourea, N-ethylthiourea, N-propylthiourea, N-butylthiourea, N-phenyithiourea, N-benzylthiourea, N,N′-dimethylthiourea, N,N′-diethylthiourea, N,N′-dipropylthiourea, N,N′-dibutylthiourea, N,N,N′,N′-tetramethylthiourea, N,N,N′,N′-tetraethylthiourea, thiocarbonyldiimidazole, and thiocarbonylbiscaprolactam. Particular preference is given to urea, thiourea, N,N′-dimethylurea, N,N′-diethylurea, N,N′-dibutylurea, N,N′-diisobutylurea, and N,N,N′,N′-tetramethylurea.

Examples of suitable amines having two primary or secondary amino groups reactive toward a urea group are ethylenediamine, N-alkylethylenediamine, propylenediamine, 2,2-dimethyl-1,3-propylenediamine, N-alkylpropylenediamine, butylenediamine, N-alkylbutylenediamine, pentanediamine, hexamethylenediamine, N-alkylhexamethylenediamine, heptanediamine, octanediamine, nonanediamine, decanediamine, dodecanediamine, hexadecanediamine, tolylenediamine, xylylenediamine, diaminodiphenylmethane, diaminodicyclohexylmethane, phenylenediamine, cyclohexylenediamine, bis(aminomethyl)cyclohexane, diaminodiphenyl sulfone, isophoronediamine, 2-butyl-2-ethyl-1,5-pentamethylenediamine, 2,2,4- or 2,4,4-trimethyl-1,6-hexamethylenediamine, 2-aminopropylcyclohexylamine, 3(4)-aminomethyl-1-methylcyclohexylamine, 1,4-diamino-4-methylpentane, amine-terminated polyoxyalkylene polyols (known as Jeffamine from Huntsman), or amine-terminated polytetramethylene glycols.

It is preferable that the amines have two primary amino groups, examples being ethylenediamine, propylenediamine, 2,2-dimethyl-1,3-propanediamine, butylenediamine, pentanediamine, hexamethylenediamine, heptanediamine, octanediamine, nonanediamine, decanediamine, dodecanediamine, hexadecanediamine, tolylenediamine, xylylenediamine, diaminodiphenylmethane, diaminocyclohexylmethane, phenylenediamine, cyclohexylenediamine, diaminodiphenyl sulfone, isophoronediamine, bis(aminomethyl)cyclohexane, 2-butyl-2-ethyl-1,5-pentamethylenediamine, 2,2,4- or 2,4,4-trimethyl-1,6-hexamethylenediamine, 2-aminopropylcyclohexylamine, 3(4)-aminomethyl-1-methylcyclohexylamine, 1,4-diamino-4-methylpentane, amine-terminated polyoxyalkylene polyols, or amine-terminated polytetramethylene glycols.

Particular preference is given to butylenediamine, pentanediamine, hexamethylenediamine, tolylenediamine, xylylenediamine, diaminodiphenylmethane, diaminodicyclohexylmethane, phenylenediamine, cyclohexylenediamine, diaminodiphenyl sulfone, isophoronediamine, bis(aminomethyl)cyclohexane, amine-terminated polyoxyalkylene polyols (Jeffamine), or amine-terminated polytetramethylene glycols.

Examples of suitable amines having three or more primary and/or secondary amino groups reactive toward a urea group are tris(aminoethyl)amine, tris(aminopropyl)amine, tris(aminohexyl)amine, trisaminohexane, 4-aminomethyl-1,8-octanediamine, trisaminononane, bis(aminoethyl)amine, bis(aminopropyl)amine, bis(aminobutyl)amine, bis(aminopentyl)amine, bis(aminohexyl)amine, N-(2-aminoethyl)propanediamine, melamine, oligomeric diaminodiphenylmethanes (polymer MDA), N,N′-bis(3-aminopropyl)ethylenedia mine, N,N′-bis(3-aminopropyl)butanediamine, N,N,N′,N′-tetra(3-aminopropyl)ethylenediamine, N,N,N′,N′-tetra(3-aminopropyl)butylenediamine, amine-terminated polyoxyalkylene polyols of functionality 3 or higher (known as Jeffamine® from Huntsman), PolyTHFamine® (BASF SE), polyethyleneimines of functionality 3 or higher, polypropyleneimines of functionality 3 or higher, or polytetramethylene glycol amines of functionality 3 or higher.

Preferred amines having three or more reactive primary and/or secondary amino groups are tris(aminoethyl)amine, tris(aminopropyl)amine, tris(aminohexyl)amine, trisaminohexane, 4-aminomethyl-1,8-octanediamine, trisaminononane, bis(aminoethyl)amine, bis(aminopropyl)amine, bis(aminobutyl)amine, bis(aminopentyl)amine, bis(aminohexyl)amine, N-(2-aminoethyl)propanediamine, melamine, amine-terminated polyoxyalkylene polyols of functionality 3 or higher (known as Jeffamine® from Huntsman), PolyTHFamine® (BASF SE), or polytetramethylene glycol amines of functionality 3 or higher.

Particular preference is given to amines having three or more primary amino groups, examples being tris(aminoethyl)amine, tris(aminopropyl)amine, tris(aminohexyl)amine, trisaminohexane, 4-aminomethyl-1,8-octanediamine, trisaminononane, amine-terminated polyoxyalkylene polyols of functionality 3 or higher (known as Jeffamine® from Huntsman), PolyTHFamine® (BASF SE), or polytetramethylene glycol amines of functionality 3 or higher.

It is also possible, of course, to use mixtures of the amines mentioned.

Alongside amines having three or more primary or secondary amino groups, use is generally made of amines having two primary or secondary amino groups. Amine mixtures of this type can also be characterized via the average amine functionality, ignoring unreactive tertiary amino groups. By way of example, an equimolar mixture made of a diamine and a triamine has average functionality of 2.5. The invention preferably reacts those amine mixtures in which the average amine functionality is from 2.1 to 10, in particular from 2.1 to 5.

The reaction of the urea with the di- or polyamine to give the high-functionality highly branched polyurea of the invention takes place with elimination of ammonia, an alkyl- or dialkylamine, or an aryl- or diarylamine. If one molecule of urea reacts with two amino groups, two molecules of ammonia or amine are eliminated, and if one molecule of urea reacts with only one amino group, one molecule of ammonia or amine is eliminated.

The reaction of the urea(s) with the amine(s) can take place in a solvent. It is possible in general terms here to use any of the solvents which are inert toward the respective starting materials. It is preferable to operate in organic solvents, such as decane, dodecane, benzene, toluene, chlorobenzene, dichlorobenzene, xylene, dimethylformamide, dimethylacetamide, or solvent naphtha.

In one preferred embodiment, the reaction is carried out in bulk, i.e. without inert solvent. The amine or the ammonia that is liberated during the reaction between amine and urea can be removed by distillation, optionally with passage of a gas over the liquid phase, or with passage of a gas through the liquid phase, optionally at subatmospheric pressure, thus being removed from the reaction equilibrium. This also accelerates the reaction.

Polyureas based on carbonates and on polyamines are advantageously produced by reacting one or more carbonates with one or more amines having at least two primary and/or secondary amino groups, where at least one amine has three primary and/or secondary amino groups (WO 2005/044897). Lines 9 to 31 on page 4 of WO 2005/044897 describe particularly suitable carbonates; page 4, line 33 to page 6, line 22 describe particularly suitable amines. Page 6, line 24 to page 7, line 21 of WO 2005/044897 describe the preferred reaction of the carbonates with the di- or polyamine.

Suitable carbonates are aliphatic, aromatic, or mixed aliphatic-aromatic carbonates, preference being given to aliphatic carbonates, such as dialkyl carbonates having C₁-C₁₂-alkyl radicals. Examples are ethylene carbonate, propylene 1,2- or 1,3-carbonate, diphenyl carbonate, ditolyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, diheptyl carbonate, dioctyl carbonate, didecyl carbonate, and didodecyl carbonate. Carbonates used with particular preference are dimethyl carbonate, diethyl carbonate, dibutyl carbonate, and diisobutyl carbonate.

Carbonates can by way of example be produced via reaction of the corresponding alcohols or phenols with phosgene. They can moreover be produced via oxidative carbonylation of the corresponding alcohols or phenols using CO in the presence of noble metals, oxygen, or NOₓ. Methods for producing carbonates are described by way of example in Ullmann's Encyclopedia of Industrial Chemistry, 6th Edition, 2000 Electronic Release, Verlag Wiley-VCH.

The carbonates are nacted with one or more amines having at least two primary and/or secondary amino groups, where at least one amine has at least three primary and/or secondary amino groups. Amines having two primary and/or secondary amino groups bring about chain extension within the polyureas, whereas amines having three or more primary or secondary amino groups are the cause of branching points in the resultant high-functionality, highly branched polyureas.

Polyureas based on di- or polyisocyanates and on di- or polyamines are advantageously produced by, in step a), reacting at least one difunctional capped di- or polyisocyanate with at least one at least difunctional primary and/or secondary amine, with elimination of the capping agent, and, in a step b), reacting the reaction products from step a) via intermolecular reaction to give a high-functionality polyurea (WO 2003/066702). Page 4, line 21 to page 6, line 11 and page 7, line 39 to page 15, line 18 of WO 2003/066702 describe more details of the process. Page 6, line 36 to page 7, line 29 of WO 2003/066702 describe particularly suitable di- or polyisocyanates; lines 13 to 34 on page 6 describe particularly preferred amines.

One embodiment of the invention uses hyperbranched polyureas which have been functionalized with an average of from 2 to 10 alkylene oxide units per NH group. Suitable alkylene oxides are ethylene oxide, propylene oxide, and butylene oxide, preference being given to propylene oxide.

Hyperbranched Polyisocyanurates

Hyperbranched polyisocyanurates are preferably produced by polymerizing tris(hydroxyethyl) isocyanurate (THEIC) intermolecularly in a condensation reaction. A process for their production is described by way of example in U.S. Pat. No. 3,293,224.

One embodiment of the invention uses a hyperbranched polyisocyanurate based on tris(hydroxyethyl) isocyanurate.

Hyperbranched Polyamides

Hyperbranched polyamides are described by way of example in U.S. Pat. No. 4,507,466, U.S. Pat. No. 6,541,600, US-A-2003055209, U.S. Pat. No. 6,300,424, U.S. Pat. No. 5,514,764 and WO 92/08749, the entire content of which is hereby incorporated herein by way of reference.

One suitable procedure for producing hyperbranched polyamides starts from polyfunctional amines and polycarboxylic acids, where at least one polyfunctional compound is used which has three or more (e.g. 4, 5, 6, etc.) functional groups. In formal terms, this procedure then reacts a first class of monomers having two identical functional groups A₂ (e.g. a dicarboxylic acid or a diamine) with a second class of monomers Bₙ, where this second class comprises at least one compound having more than two functional groups (e.g. at least one tricarboxylic acid (n=3) or one carboxylic acid of functionality higher than three or, respectively, at least one triamine (n=3), or one amine having functionality higher than three). It is preferable that the second class of monomers comprises at least one difunctional monomer B₂, where this has two functional groups complementary to the monomers A₂. It is preferable that the average functionality of the monomers Bₙ is at least 2.1 (n=2.1). For production of hyperbranched polyamides by this variant, it is preferable to use the monomers A₂ in a molar excess with respect to the monomers Bₙ. It is preferable that the molar ratio of monomers A₂ with respect to monomers Bₙ is in the range from 1:1 to 20:1, particularly preferably from 1.1:1 to 10:1, in particular from 1.2:1 to 5:1. One preferred embodiment begins by producing a hyperbranched prepolymer having terminal groups A, and then further reacts this with at least one monomer B₂ and/or Bₙ. To produce the prepolymer, it is preferable to use monomers A₂ and monomers Bₙ in a molar ratio of from 1:1 to 20:1, particularly from 1.1:1 to 10:1, and in particular from 1.2:1 to 5:1.

Another suitable procedure for producing hyperbranched polyamides starts from polyfunctional aminocarboxylic acids, where at least one polyfunctional compound is used which has three or more (e.g. 4, 5, 6, etc.) functional groups, i.e what is known as an ABₓ monomer (x being greater than or equal to 2). These can then be reacted with further monomers AB, A₂ and/or B₂. An example of a suitable aminocarboxylic acid is lysine.

Examples of suitable dicarboxylic acids are oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid, phthalic acid, isophthalic acid, terephthalic acid, and mixtures thereof.

The abovementioned dicarboxylic acids can also have substitution. Suitable substituted dicarboxylic acids can have one or more radicals preferably selected from alkyl, cycloalkyl, and aryl, as defined in the introduction. Examples of suitable substituted dicarboxylic acids are 2-methylmalonic acid, 2-ethylmalonic acid, 2-phenylmalonic acid, 2-methylsuccinic acid, 2-ethylsuccinic acid, 2-phenylsuccinic acid, itaconic acid, and 3,3-dimethylglutaric acid.

The dicarboxylic acids can either be used as they stand or in the form of derivatives. Suitable derivatives are anhydrides and their oligomers and polymers, mono- and diesters, preferably mono- and dialkyl esters, and acyl halides, preferably chlorides. Suitable esters are mono- or dimethyl esters, mono- or diethyl esters, and also mono- and diesters of higher alcohols, such as n-propanol, isopropanol, n-butanol, isobutanol, tert-butanol, n-pentanol, n-hexanol, etc., and also mono- and divinyl esters, and also mixed esters, preferably methyl ethyl esters.

It is also possible to use a mixture made of a dicarboxylic acid and of one or more of its derivatives. It is likewise possible to use a mixture made of a plurality of different derivatives of one or more dicarboxylic acids.

It is particularly preferable to use succinic acid, glutaric acid, adipic acid, phthalic acid, isophthalic acid, terephthalic acid, or mono- or dimethyl ester thereof. It is very particularly preferable to use adipic acid.

Suitable polyfunctional amines for producing hyperbranched polyamides have two or more (e.g. 3, 4, 5, 6, etc.) primary or secondary amino groups capable of amide formation.

Suitable diamines are straight-chain and branched, aliphatic and cycloaliphatic amines generally having about 2 to 30, preferably about 2 to 20, carbon atoms. Examples of suitable diamines are those of the general formula R¹—NH—R²—NH—R³, in which R¹ and R³, independently of one another, are hydrogen, alkyl, cycloalkyl, or aryl, and R² is alkylene, cycloalkylene, or arylene. Among these are ethylenediamine, 1,2-diaminopropane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, N-alkylethylenediamines, such as N-methylethylenediamine and N-ethylethylenediamine, N,N′-dialkylethylenediamines, such as N,N′-dimethylethylenediamine, N-alkylhexamethylenediamines, such as N-methylhexamethylenediamine, piperazine, bis(4-aminocyclohexyl)methane, phenylenediamine, isophoronediamine, bis(2-aminoethyl)ether, 1,2-bis(2-aminoethoxy)ethane, and amine-terminated polyoxyalkylene diols (known as Jeffamine® (Huntsman) or α,ω-diaminopolyethers), where these can be produced by way of example via amination of difunctional polyalkylene oxides with ammonia.

Examples of suitable triamines are bis(2-aminoethyl)amine (=diethylenetriamine), N,N′-diethyldiethylenetriamine, bis(3-aminopropyl)amine, bis(6-aminohexyl)amine, 4-aminomethyl-1,8-octamethylenediamine, N′-(3-aminopropyl)-N,N-dimethyl-1,3-propanediamine, melamine, PolyTHFamine® (BASF SE), and amine-terminated polyoxyalkylenetriols (known as Jeffamine® (Huntsman) or α,ω-diaminopolyethers), where these can be produced by way of example via amination of trifunctional polyalkylene oxides with ammonia.

Suitable polyfunctional amines are N,N′-bis(2-aminoethyl)ethylenediamine (=triethylenetetramine), N,N′-bis(2-aminoethyl)-1,3-diaminopropane, N,N′-bis(3-aminopropyl)-1,4-diaminobutane (=spermine), N,N′-bis(2-aminoethyl)piperazine, N,N′-bis(3-aminopropyl)piperazine, tris(2-aminoethyl)amine, tris(3-aminopropyl)amine, tris(6-aminohexyl)amine, and amine-terminated polyoxyalkylene polyols (known as Jeffamine® (Huntsman) or α,ω-diaminopolyethers), where these can be produced by way of example via amination of polyfunctional polyalkylene oxides with ammonia.

Polymeric polyamines are also suitable. These generally have a number-average molecular weight of about 500 to 50 000, preferably about 1000 to 30 000. Examples among these are polyamine having terminal, primary or secondary amino groups, polyalkyleneimines, preferably polyethyleneimines, and vinylamines obtained via hydrolysis of poly-N-vinylamides, e.g. poly-N-vinylacetamide, the abovementioned α,ω-diamines based on aminated polyalkylene oxides, and also copolymers which comprise copolymerized α,ω-ethylenically unsaturated monomers having appropriate functional groups, e.g. aminomethyl acrylate, aminoethyl acrylate, (N-methyl)aminoethyl acrylate, (N-methyl)aminoethyl methacrylate, etc.

The hyperbranched polyamides can be produced in the presence of a conventional catalyst. Examples among these are metal oxides and metal carbonates, strong acids, terephthalates, titanium halides, titanium alkoxides, and titanium carboxylates, etc. Suitable catalysts are disclosed by way of example in U.S. Pat. No. 2,244,192, U.S. Pat. No. 2,669,556, SU 775 106, and U.S. Pat. No. 3,705,881. Other suitable catalysts are mentioned hereinafter in the context of the polyesteramides.

Hyperbranched Polyesteramides

Suitable hyperbranched polyesteramides are described by way of example in WO 99/16810, and WO 00/56804, and WO 2006/018126.

In very general terms, polyesteramides are polymeric compounds which have ester groups and amide groups. Compounds that can be used to produce hyperbranched polyesteramides are in principle at least divalent compounds selected from polycarboxylic acids, hydroxycarboxylic acids, aminocarboxylic acids, aminoalcohols, polyamines, polyols, and derivatives of the abovementioned compounds. One proviso here is that the compounds are selected in such a way that the resultant polymers have both ester groups and amide groups. Another proviso here is that the compounds are selected in such a way that at least one polyfunctional compound is used that has three or more (e.g. 4, 5, 6, etc.) functional groups.

One suitable procedure for producing hyperbranched polyesteramides starts from polyfunctional aminoalcohols and polycarboxylic acids, where at least one polyfunctional compound is used which has three or more (e.g. 4, 5, 6, etc.) functional groups.

Another suitable procedure for producing hyperbranched polyesteramides starts from polyfunctional amines, and polyfunctional alcohols and polycarboxylic acids, where at least one polyfunctional compound is used which has three or more (e.g. 4, 5, 6, etc.) functional groups.

Suitable polyfunctional aminoalcohols for producing hyperbranched polyesteramides have two or more (e.g. 3, 4, 5, 6, etc.) functional groups selected from hydroxy groups and primary and secondary amino groups. By definition, aminoalcohols here always have at least one hydroxy group and at least one primary or secondary amino group. Suitable aminoalcohols are straight-chain and branched, aliphatic and cycloaliphatic aminoalcohols generally having from 2 to 30, preferably from 2 to 20, carbon atoms.

Examples of suitable difunctional aminoalcohols are 2-aminoethanol (=monoethanolamine), 3-amino-1-propanol, 2-amino-1-propanol, 1-amino-2-propanol, 2-amino-3-phenylpropanol, 2-amino-2-methyl-1-propanol, 2-amino-1-butanol, 4-amino-1-butanol, 2-aminoisobutanol, 2-amino-3-methyl-1-butanol, 2-amino-3,3-dimethylbutanol, 1-amino-1-pentanol, 5-amino-1-pentanol, 2-amino-1-pentanol, 2-amino-4-methyl-1-pentanol, 2-amino-3-methyl-1-pentanol, 2-aminocyclohexanol, 4-aminocyclohexanol, 3-(aminomethyl)-3,5,5-trimethylcyclohexanol, 2-amino-1,2-diphenylethanol, 2-amino-1,1-diphenylethanol, 2-amino-2-phenylethanol, 2-amino-1-phenylethanol, 2-(4-aminophenyl)ethanol, 2-(2-aminophenyl)ethanol, 1-(3-aminophenyl)ethanol, 2-amino-1-hexanol, 6-amino-1-hexanol, 6-amino-2-methyl-2-heptanol, N-methylisopropanolamine, N-ethylisopropanolamine, N-methylethanolamine, 1-ethylaminobutan-2-ol, 4-methyl-4-aminopentan-2-ol, 2-(2-amino-ethoxy)ethanol, N-(2-hydroxyethyl)piperazine, 1-amino-2-indanol, N-(2-hydroxyethyl)aniline, aminosugars, such as D-glucoseamine, D-galactoseamine, 4-amino-4,6-didesoxy-α-D-glucopyranose, and mixtures thereof.

Examples of suitable tri- and polyfunctional aminoalcohols are N-(2-hydroxyethyl)ethylenediamine, diethanolamine, dipropanolamine, diisopropanolamine, 2-amino-1,3-propanediol, 3-amino-1,2-propanediol, tris(hydroxymethyl)aminomethane.

Suitable polycarboxylic acids for producing hyperbranched polyesteramides are those described above for producing hyperbranched polyamides. The entire content of the suitable and preferred information provided there is hereby incorporated herein by way of reference.

Suitable polyfunctional amines for producing hyperbranched polyesteramides are those described above for producing hyperbranched polyamides. The entire content of the suitable and preferred information provided there is hereby incorporated herein by way of reference.

Suitable polyfunctional alcohols for producing hyperbranched polyesteramides have two or more (e.g. 3, 4, 5, 6, etc.) hydroxy groups. Some or all of the hydroxy groups here can also have been replaced by mercapto groups.

Suitable diols are straight-chain and branched, aliphatic and cycloaliphatic alcohols generally having about 2 to 30, preferably about 2 to 20, carbon atoms. Among these are 1,2-ethanediol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 2,3-pentanediol, 2,4-pentanediol, 1,2-hexanediol, 1,3-hexanediol, 1,4-hexanediol, 1,5-hexanediol, 1,6-hexanediol, 2,5-hexanediol, 1,2-heptanediol, 1,7-heptanediol, 1,2-octanediol, 1,8-octanediol, 1,2-nonanediol, 1,9-nonanediol, 1,2-decanediol, 1,10-decanediol, 1,12-dodecanediol, 2-methyl-1,3-propanediol, 2-methyl-2-butyl-1,3-propanediol, 2,2-dimethyl-1,3-propanediol, 2,2-dimethyl-1,4-butanediol, pinacol, 2-ethyl-2-butyl-1,3-propanediol, diethylene glycol, triethylene glycol, dipropylene glycol, tripropylene glycol, polyalkylene glycols, cyclopentanediols and cyclohexanediols.

Examples of suitable triols are glycerol, butane-1,2,4-triol, n-pentane-1,2,5-triol, n-pentane-1,3,5-triol, n-hexane-1,2,6-triol, n-hexane-1,2,5-triol, trimethylolpropane, and trimethylolbutane. Other suitable triols are the triesters of hydroxycarboxylic acids with trifunctional alcohols. These are preferably triglycerides of hydroxycarboxylic acids, e.g. lactic acid, hydroxystearic acid, and ricinoleic acid. Naturally occurring mixtures comprising hydroxycarboxylic triglycerides are also suitable, in particular castor oil. Examples of suitable polyfunctional polyols are sugar alcohols and their derivatives, e.g. erythritol, pentaerythritol, dipentaerythritol, threitol, inositol, and sorbitol. Other suitable compounds are reaction products of the polyols with alkylene oxides, such as ethylene oxide and/or propylene oxide. It is also possible to use relatively high-molecular-weight polyols with number-average molar mass in the range of about 400 to 6000 g/mol, preferably from 500 to 4000 g/mol. Among these are, for example, polyesterols based on aliphatic, cycloaliphatic, and/or aromatic di-, tri- and/or polycarboxylic acids with di-, tri-, and/or polyols, and also the polyesterols based on lactone. Among these are also polyetherols which are obtainable by way of example via polymerization of cyclic ethers or via reaction of alkylene oxides with a starter molecule. Among these are also conventional polycarbonates known to the person skilled in the art having terminal hydroxy groups, where these are obtainable via reaction of the diols described above, or else of bisphenols, such as bisphenol A, with phosgene or carbonic diesters. Other suitable compounds are α,ω-polyamidols, α,ω-polymethyl (meth)acrylate diols and/or α,ω-polybutyl (meth)acrylate diols, e.g. MD-1000 and BD-1000 from Goldschmidt.

Hyperbranched polyesteramides can be produced by conventional processes known to the person skilled in the art. A first embodiment produces hyperbranched polyesteramides in a single-stage one-pot process starting from polyfunctional aminoalcohols and dicarboxylic acids, where at least one polyfunctional aminoalcohol is used which has three or more (e.g. 4, 5, 6, etc.) functional groups. The molar ratio of dicarboxylic acid to aminoalcohol is preferably in the range from 2:1 to 1.1:1, particularly from 1.5:1 to 1.2:1. If a suitable embodiment of said single-stage process uses only dicarboxylic acids, i.e. monomers of type A₂, and trifunctional aminoalcohols, i.e. monomers of type B₃, it is useful to interrupt the reaction before the gel point has been reached. For the definition of the gel point, see Flory, Principles of Polymer Chemistry, Cornell University Press, 1953, pp. 387 to 398. The gel point can be calculated from Flory's theory or else determined by monitoring the viscosity of the reaction mixture. A practical method terminates the reaction as soon as a rapid viscosity rise is observed.

A second embodiment produces hyperbranched polyesteramides in a two-stage one-pot process. Here, a prepolymer having free carboxylic acid groups is first produced in the first stage, and this is then reacted, in a second stage, with polyfunctional compounds which have functional groups capable of ester formation and, respectively, amide formation. In one suitable embodiment, the carboxylic acids A₂ and aminoalcohols B₃ are used in the first stage to produce the prepolymers. The molar ratio of dicarboxylic acid to aminoalcohol is preferably in the range from 2:1 to 10:1, particularly from 2.5:1 to 5:1, and in particular from 2.7:1 to 4:1. In this procedure, gelling of the reaction mixture can generally easily be avoided even at relatively high conversion rates. For further reaction of the prepolymers in the second stage, the abovementioned polyfunctional amines, aminoalcohols, and polyamines can optionally be used in combination with further polycarboxylic acids. Reference is made to what has been said above in relation to suitable and preferred embodiments of said compounds. It is preferable that the second reaction stage uses predominantly or exclusively difunctional compounds, for the purposes of chain extension.

Polymers comparable with those that are obtained by the two-stage one-pot process can also be obtained when the hyperbranched polyesteramides obtained by the single-stage one-pot process described above are subjected to subsequent modification, for the purposes of polymer-analogous reaction, where said polymer-analogous reaction can then use the abovementioned polyfunctional amines, alcohols, aminoalcohols, and carboxylic acids. Another possibility is naturally a polymer-analogous reaction not only of the hyperbranched polyesteramides obtained by the single-stage process but also of the hyperbranched polyesteramides obtained by the two-stage process, with monofunctional compounds, e.g. monoalcohols, monoamines, and monocarboxylic acids, as described in more detail hereinafter. These can have additional functional groups for further modification of the properties of the polymers. Examples of suitable terminators are fatty acids, fatty acid derivatives, such as anhydrides and esters, fatty alcohols, and acids and acid derivatives, where these have further functional groups, and also alcohols and amines, where these have further functional groups.

The esterification and amidation reaction for producing hyperbranched polyesteramides, and also the amidation reaction for producing hyperbranched polyamides, can take place in the presence of at least one catalyst. Examples of suitable catalysts are acidic catalysts, organometallic catalysts and enzymes.

Examples of suitable acidic catalysts are sulfuric acid, phosphoric acid, phosphonic acid, hypophosphorous acid, aluminum sulfate hydrate, alum, acidic silica gel, and acidic aluminum oxide. Other suitable catalysts are organoaluminum compounds of the general formula Al(OR)₃ and organotitanium compounds of the general formula Ti(OR)₄, where the radicals R, independently of one another, are alkyl or cycloalkyl as defined in the introduction. Examples of preferred radicals R are those selected from isopropyl and 2-ethylhexyl.

Examples of preferred acidic organometallic catalysts are those selected from dialkyltin oxides of the general formula R₂SnO, in which R, independently of one another, are alkyl or cycloalkyl as defined in the introduction. Among these is preferably di-n-butyltin oxide, which is commercially available as “oxotin”.

Other suitable acidic organic catalysts are acidic organic compounds which have at least one acid group selected from phosphoric acid groups, phosphonic acid groups, sulfoxy groups, sulfonic acid groups, etc. An example of a preferred compound is p-toluenesulfonic acid. Other suitable catalysts are acidic ion exchangers, for example polystyrene resins modified with sulfonic acid groups and crosslinked in a conventional manner, e.g. with divinylbenzene.

Hyperbranched Polyesteramines

For the purposes of the present invention, the term polyesteramines very generally means polymeric compounds which have ester groups and amino groups within the polymer chain, where the amino groups are not part of an amide group. To produce hyperbranched polyesteramines it is possible in principle to use at least divalent compounds which have an amino group that is preferably no longer available for any subsequent reaction, and which also have at least two further functional groups capable of an addition or condensation reaction. Among these are by way of example N-(alkyl)-N-(hydroxyalkyl)aminoalkylcarboxylic acids and their derivatives, N,N-di(hydroxyalkyl)aminoalkylcarboxylic acids and their derivatives, N-(alkyl)-N-(aminoalkyl)aminoalkylcarboxylic acids and their derivatives, N,N-di(aminoalkyl)aminoalkylcarboxylic acids and their derivatives, etc. The hyperbranched polyesteramines used in the invention can comprise, incorporated alongside these monomers, other polyfunctional compounds which have two or more (e.g. 3, 4, 5, 6, etc.) functional groups. Among these are the following compounds described above: polycarboxylic acids, polyfunctional amines, polyfunctional alcohols, and polyfunctional aminoalcohols.

It is preferable that the hyperbranched polyesteramines are produced with use of AB₂ monomers and/or of AB₃ monomers, where these are obtainable via a reaction of the Michael-addition type.

One first embodiment for production of an AB₂ monomer via Michael addition reacts an aminoalcohol which has a secondary amino group and two hydroxy groups with a compound having an activated double bond, e.g. with a vinylogous carbonyl compound.

Examples of suitable aminoalcohols which have a secondary amino group and two hydroxy groups are diethanolamine, dipropanolamine, diisopropanolamine, 2-amino-1,3-propanediol, 3-amino-1,2-propanediol, diisobutanolamine and dicyclohexanolamine.

Suitable compounds having an activated double bond are preferably those selected from esters of α, ω-ethylenically unsaturated mono- and dicarboxylic acids with monofunctional alcohols. The α,ω-ethylenically unsaturated mono- and dicarboxylic acids are preferably those selected from acrylic acid, methacrylic acid, fumaric acid, maleic acid, itaconic acid, crotonic acid, maleic anhydride, monobutyl maleate, and mixtures of these. The acid component used preferably comprises acrylic acid, methacrylic acid, or a mixture thereof. Preferred vinylogous compounds are methyl(meth)acrylate, methyl ethacrylate, ethyl(meth)acrylate, ethyl ethacrylate, n-butyl(meth)acrylate, tert-butyl(meth)acrylate, tert-butyl ethacrylate, n-octyl(meth)acrylate, 1,1,3,3-tetramethylbutyl(meth)acrylate, ethylhexyl(meth)acrylate, n-nonyl(meth)acrylate, n-decyl(meth)acrylate, n-undecyl(meth)acrylate, tridecyl(meth)acrylate, myristyl(meth)acrylate, pentadecyl(meth)acrylate, palmityl(meth)acrylate, heptadecyl(meth)acrylate, nonadecyl(meth)acrylate, arachinyl(meth)acrylate, behenyl(meth)acrylate, lignoceryl(meth)acrylate, cerotyl(meth)acrylate, melissyl(meth)acrylate, palmitoleyl(meth)acrylate, oleyl(meth)acrylate, linoleyl(meth)acrylate, linolenyl(meth)acrylate, stearyl(meth)acrylate, lauryl(meth)acrylate, and mixtures thereof. Particular preference is given to methyl acrylate and to n-butyl acrylate.

In a second embodiment for producing an AB₂ monomer via Michael addition, an aminoalcohol which has a primary amino group and a hydroxy group is reacted with a compound having an activated double bond.

Suitable aminoalcohols which have a primary amino group and a hydroxy group are the difunctional aminoalcohols mentioned above for producing hyperbranched polyesteramides. Suitable compounds having an activated double bond are those mentioned above in the first embodiment for producing an AB₂ monomer via Michael addition.

In a third embodiment for producing an AB₃ monomer via Michael addition, an aminoalcohol which has a primary amino group, a secondary amino group, and a hydroxy group is reacted with three activated double bonds.

A suitable aminoalcohol which has a primary amino group, a secondary amino group, and a hydroxy group is hydroxyethylethylenediamine. Suitable compounds having activated double bonds are those mentioned above in the first embodiment for producing an AB₂ monomer via Michael addition.

It is preferable that the reaction of Michael addition type takes place in bulk or in a solvent which is inert under the conditions of the reaction. Examples of suitable solvents are relatively high-boiling-point alcohols, such as glycerol, and aromatic hydrocarbons, such as benzene, toluene, xylene, etc. The reaction preferably takes place at a temperature in the range from 0 to 100° C., particularly preferably from 5 to 80° C., and in particular from 10 to 70° C. It is preferable that the reaction takes place in the presence of an inert gas, such as nitrogen, helium, or argon, and/or in the presence of a free-radical inhibitor. The person skilled in the art is aware of general operating specifications for the addition reaction of aminoalcohols onto activated double bonds. In one preferred embodiment, the monomers are produced via Michael addition and they are then reacted in a polycondensation process in the form of a one-pot reaction.

Conventional processes known to the person skilled in the art are used to produce the hyperbranched polyesteramines from the abovementioned or other ABₓ monomers. In one suitable procedure, polyesteramines suitable in the invention are produced with use of the AB₂ monomers which have been described above and which are obtainable via Michael addition. These can also be reacted in the presence of further polyfunctional monomers. Suitable polyfunctional monomers are the following, which were mentioned above in the context of production of hyperbranched polyesteramides: polyfunctional aminoalcohols, polyfunctional amines, polyfunctional alcohols, and polycarboxylic acids. If desired, it is also possible to use hydroxycarboxylic acids as chain extenders. Among these are, for example, lactic acid, glycolic acid, etc.

In one suitable embodiment, the hyperbranched polyesteramines are produced in the presence of an A₂B₂ monomer. This is preferably one selected from 2-amino-2-ethyl-1,3-propanediol, 2-amino-2-methyl-1,3-propanediol, 1-amino-2,3-propanediol, 2-amino-1,3-propanediol, and 2-amino-1-phenyl-1,3-propanediol.

In another suitable embodiment, the hyperbranched polyesteramines are produced in the presence of what is known as a core molecule. Examples of suitable core molecules are trimethylolpropane, pentaerythritol, alkoxylated polyols, such as ethoxylated trimethylolpropane, ethoxylated glycerol, propoxylated trimethylolpropane, propoxylated glycerol, polyamines, such as tris(2-aminoethyl)amine, ethylenediamine, hexamethylenediamine, diethanolamine and diisopropanolamine. The core-forming monomers can be added at the start of the reaction or during its course.

In another suitable embodiment, the hyperbranched polyesteramines are produced with use of an aromatic AB₂ monomer. Examples of suitable aromatic AB₂ monomers are amidol, aminobenzyl alcohol, 2-amino-5-chlorobenzyl alcohol and 2-amino-9-fluorenol.

The polycondensation reaction for producing hyperbranched polyesteramines can take place in the presence of a catalyst. Suitable catalysts are those described above for producing the hyperbranched polyesteramides. Other suitable catalysts are enzymes, such as lipases or esterases. Suitable lipases or esterases are obtainable from Candida cylindracea, Candida lipolytica, Candida rugosa, Candida antarctica, Candidautilis, Chromobacterium viscosum, Geotrichum viscosum, Geotrichum candidum, Mucor javanicus, Mucor mihei, porcine pancreas, Pseudomonas spp., Pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, esterases derived from Bacillus spp. and Bacillus thermoglucosidasius. Preferred enzymes are Candida antarctica lipase B, and particularly immobilized Candida antarctica lipase B, as are commercially available from Novozymes Biotech Inc. as Novozyme 435.

In the case of enzymatic catalysis, the reaction can advantageously be carried out at low temperatures in the range of about 40 to 90° C., preferably 60 to 70° C. The enzymatic reaction preferably takes place in the presence of an inert gas, such as carbon dioxide, nitrogen, argon, and helium.

Very particular preference is given to hyperbranched polyureas having from 4 to 300 functional terminal groups, having a degree of branching of from 0.1 to 0.99, and having a molar mass Mₙ of from 1500 to 200 000 g/mol, and in particular to hyperbranched polyureas having from 10 to 200 functional terminal groups, having a degree of branching of from 0.2 to 0.9, and having a molar mass of from 2000 to 150 000 g/mol, and particular preference is given to hyperbranched polyureas having from 20 to 150 functional terminal groups, having a degree of branching of from 0.3 to 0.75, and having a molar mass of from 2500 to 100 000 g/mol, in particular from 5000 to 60 000 g/mol.

Particular preference is further given to hyperbranched polyamides having from 4 to 300 functional terminal groups, having a degree of branching of from 0.1 to 0.99, and having a molar mass of from 1500 to 200 000 g/mol, and in particular to hyperbranched polyamides having from 10 to 200 functional terminal groups, having a degree of branching of from 0.2 to 0.9, and having a molar mass of from 2000 to 150 000 g/mol, and particular preference is given to hyperbranched polyamides having from 20 to 150 functional terminal groups, having a degree of branching of from 0.3 to 0.75, and having a molar mass of from 2500 to 100 000 g/mol, in particular from 2500 to 60 000 g/mol.

Particular preference is further given to hyperbranched polylysines having from 4 to 300 functional terminal groups, having a degree of branching of from 0.1 to 0.99, and having a molar mass of from 1500 to 200 000 g/mol, and in particular to hyperbranched polylysines having from 10 to 200 functional terminal groups, having a degree of branching of from 0.2 to 0.9, and having a molar mass of from 2000 to 150 000 g/mol, and particular preference is given to hyperbranched polylysines having from 20 to 150 functional terminal groups, having a degree of branching of from 0.3 to 0.75, and having a molar mass of from 2500 to 100 000 g/mol, in particular from 2500 to 60 000 g/mol.

Polylysine is preferably produced by reacting
(A) a salt of lysine with at least one acid,
(B) optionally at least one other amino acid other than lysine,
(C) optionally at least one di- or polycarboxylic acid, or copolymerizable derivatives thereof, and
(D) optionally at least one di- or polyamine or copolymerizable derivatives thereof,
(E) optionally in at least one solvent at a temperature of from 120 to 200° C.
in the presence of at least one catalyst (F) selected from the group consisting of
   (F1) tertiary amines and amidines,
   (F2) basic alkali metal, alkaline earth metal, or quaternary ammonium salts, and
   (F3) alkanolates, alkanoates, chelates, or organometallic compounds of the metals of groups IIIA to VIIIA or IB to VB of the periodic table of the elements.

The synthetic process is described in more detail in DE-A-102005056592.

The hyperbranched polyureas are advantageously produced by the synthetic processes described in WO 2005/075541, WO 2005/044897, WO 2003/066702, the hyperbranched polyamides are advantageously produced by the synthetic processes described in WO 2006/018125, and the hyperbranched polylysines are advantageously produced by the synthetic processes described in DE-A-102005056592 and in the document with title “Herstellung and Verwendung von hochfunktionellen, hoch-oder hyperverzweigten Polylysinen” [Production and use of high-functionality, highly branched or hyperbranched polylysines].

Amounts generally used of the nitrogen-containing hyperbranched polymers are from 1 to 50% by weight, preferably from 5 to 20% by weight, based on all of components (a) to (g) of the reaction mixture.

It is possible to use other flame retardants, alongside the nitrogen-containing hyperbranched polymers.

Other flame retardants that can be used are organic phosphoric and/or phosphonic esters, and among the preferred compounds are also phosphoric esters comprising chlorine. Typical representatives of this group of flame retardants are triethyl phosphate, diphenyl cresyl phosphate, tris(chloropropyl) phosphate, and also diethyl ethanephosphonate.

Alongside these, it is also possible to use flame retardants comprising bromine. Flame retardants that are preferably used and that comprise bromine are compounds having groups reactive toward the isocyanate group. Compounds of this type are esters of tetrabromophthalic acid with aliphatic diols, and others are alkoxylation products of dibromobutenediol. It is also possible to use compounds which derive from the group of the brominated neopentyl compounds comprising OH groups.

Particular preference is given to those flame retardants which comprise no halogen atoms.

Chain Extenders

Chain extenders and/or crosslinking agents (d) used comprise substances with molar mass that is preferably smaller than 500 g/mol, particularly preferably from 60 to 400 g/mol, where chain extenders have two hydrogen atoms reactive toward isocyanates, and crosslinking agents have at least three hydrogen atoms reactive toward isocyanate. These can be used individually or in the form of a mixture. It is preferable to use diols and/or triols having molecular weights smaller than 400, particularly preferably from 60 to 300, and in particular from 60 to 150. Examples of those that can be used are aliphatic, cycloaliphatic, and/or araliphatic diols having from 2 to 14, preferably from 2 to 10, carbon atoms, e.g. ethylene glycol, 1,3-propanediol, 1,10-decanediol, o-, m-, or p-dihydroxycyclohexane, diethylene glycol, dipropylene glycol, and preferably 1,4-butanediol, 1,6-hexanediol, and bis(2-hydroxyethyl)hydroquinone, triols, such as 1,2,4- or 1,3,5-trihydroxycyclohexane, glycerol, and trimethylolpropane, and low-molecular-weight hydroxylated polyalkylene oxides based on ethylene oxide and/or on propylene 1,2-oxide, and on the abovementioned diols and/or triols as starter molecules. Particularly preferred chain extenders (d) used are monoethylene glycol, 1,4-butanediol, and/or glycerol.

To the extent that chain extenders, crosslinking agents, or a mixture made of these are used, the amounts of these are usefully from 1 to 60% by weight, preferably from 1.5 to 50% by weight, and in particular from 2 to 40% by weight, based on the weight of components (b), (c), and (d).

Catalysts

Catalysts (e) preferably used to produce the polyurethane foams are compounds which markedly accelerate the reaction of the compounds comprising hydroxy groups in component (b), (c) and optionally (d) with the polyisocyanates (a). Examples that may be mentioned are amidines, such as 2,3-dimethyl-3,4,5,6-tetrahydropyrimidine, tertiary amines, such as triethylamine, tributylamine, dimethylbenzylamine, N-methyl-, N-ethyl-, and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine. It is likewise possible to use organometallic compounds, preferably organotin compounds, such as stannous salts of organic carboxylic acids, e.g. stannous acetate, stannous octoate, stannous ethylhexanoate, and stannous laurate, and the dialkyltin(IV) salts of organic carboxylic acids, e.g. dibutyltin diacetate, dibutyltin dilaurate, dibutyltin maleate, and dioctyltin diacetate, and also bismuth carboxylates, such as bismuth(III) neodecanoate, bismuth 2-ethylhexanoate, and bismuth octanoate, or a mixture thereof. The organometallic compounds can be used alone, or preferably in combination with strongly basic amines. If component (b) is an ester, it is preferable to use exclusively amine catalysts. For catalysis of isocyanurate formation from isocyanates, a catalyst often used comprises the ammonium and alkali metal salts of organic carboxylic acids, e.g. potassium formate, potassium acetate, potassium octoate, potassium ethylhexanoate, or the corresponding tetraalkylammonium salts or trialkylhydroxyalkylammonium salts.

It is preferable to use from 0.001 to 5% by weight, in particular from 0.05 to 2% by weight, of catalyst or catalyst combination, based on the weight of components (b), (c), and (d).

Blowing Agents and Additives

Blowing agents (f) are also present during the production of polyurethane foams. Blowing agents (f) that can be used comprise blowing agents having chemical action and/or compounds having physical action. The term chemical blowing agents means compounds which form gaseous products via reaction with isocyanate, an example being water or formic acid. The term physical blowing agents means compounds which have been emulsified or dissolved in the starting materials for polyurethane production and vaporize under the conditions of polyurethane formation. Examples of these are hydrocarbons, halogenated hydrocarbons, and other compounds, e.g. perfluorinated alkanes, such as perfluorohexane and fluorochlorocarbons, and ethers, esters, ketones, and/or acetals, examples being (cyclo)aliphatic hydrocarbons having from 4 to 8 carbon atoms, fluorocarbons, such as Solkane® 365 mfc, or gases, such as carbon dioxide. One preferred embodiment uses, as blowing agent, a mixture made of said blowing agents comprising water. If no water is used as blowing agent, it is preferable to use exclusively physical blowing agents.

In one preferred embodiment, the content of physical blowing agents (f) is in the range from 1 to 20% by weight, in particular from 5 to 20% by weight, and the amount of water is preferably in the range from 0.5 to 10% by weight, in particular from 1 to 5% by weight. It is preferable to use carbon dioxide as blowing agent (f).

Examples of auxiliaries and/or additives (g) used are surfactant substances, foam stabilizers, cell regulators, external and internal lubricants, fillers, pigments, hydrolysis stabilizers, and also substances having fungistatic and bacteriostatic action.

In the industrial production of polyurethane foams it is conventional, prior to the reaction with the polyisocyanate (a), to form what is known as a polyol component by combining the compounds (b) having at least two active hydrogen atoms, and one or more of the starting materials (c) to (g), to the extent that these have not been previously used to produce polyisocyanate prepolymers.

Further information concerning the starting materials used is found by way of example in Kunststoffhandbuch, volume 7, Polyurethane, edited by Günter Oertel, Carl-Hanser-Verlag, Munich, 3rd edition 1993.

To produce the polyurethanes of the invention, the organic polyisocyanates are reacted with the compounds having at least two active hydrogen atoms in the presence of the abovementioned blowing agents, catalysts, and auxiliaries and/or additives (polyol component).

The general method used to produce the flexible polyurethane foams of the invention reacts the polyisocyanates (a), the compounds (b) having at least two reactive hydrogen atoms, the nitrogen-containing hyperbranched polymers (c), and optionally the chain extenders and/or crosslinking agents (d) in amounts such that the equivalence ratio of NCO groups in the polyisocyanates (a) to the entirety of the reactive hydrogen atoms in components (b), (c) and optionally (d) and (f) is from 0.7 to 1.25:1, preferably from 0.80 to 1.15:1. A ratio of 1:1 here corresponds to an isocyanate index of 100. For rigid polyurethane foams of the invention, the ratio of NCO groups in the polyisocyanates (a) to the entirety of the reactive hydrogen atoms in components (b), (c), and optionally (d) and (f) is from 1.00 to 5.00, preferably from 1.25 to 1.80. In the case of rigid polyurethane foams of the invention which specifically comprise isocyanurate structures, the ratio is greater than 1.80, preferably from 1.9 to 5.00.

The polyurethane foams are preferably produced by the one-shot process, for example with the aid of high-pressure or low-pressure technology. The foams can be produced in open or closed metallic molds or via continuous application of the reaction mixture to belt lines for production of foam slabs.

Operations can follow what is known as the two-component process, in which, as stated above, a polyol component is produced and foamed with polyisocyanate a). The components are preferably mixed at a temperature in the range from 15 to 120° C., preferably from 20 to 80° C., and placed in the mold or, respectively, on the belt line. The temperature in the mold is mostly in the range from 15 to 120° C., preferably from 30 to 80° C.

However, in the case of flexible polyurethane foams and also of rigid polyurethane foams, multicomponent processes are also conventional, and in an example here blowing agents and catalysts are added additionally and separately from the polyol component.

The examples below provide further explanation of the invention.

### INVENTIVE EXAMPLE 1

Synthesis of a Hyperbranched Polyurea Comprising Amino Groups and Comprising Urea Groups (Polymer 1a)

1 equivalent of urea and 1 equivalent of the trifunctional amine tris(3-aminopropyl)amine (TAPA) were used as initial charge at room temperature in a round-bottomed flask of appropriate size, equipped with a stirrer, reflux condenser, internal thermometer, and gas-outlet tube, and heated to about 100° C., with stirring. The ammonia produced here was introduced by way of the gas-outlet tube, connected to a gas-input frit, into a washer using aqueous hydrochloric acid solution (c_{HCl}=30% by weight). An appropriate amount of hydrochloric acid, to which a few drops of an indicator solution (e.g. bromophenol blue) had been admixed, was used as initial charge in the washer here, and corresponded to the amount of ammonia formed at the intended conversion (from 50 to 100%). The temperature was therefore increased in steps during the course of the reaction (about 10° C. of temperature rise per 1 h of reaction time, maximum temperature: 150° C.) until a change in the color of the indicator was discernible in the washer. The product was then cooled and analyzed.

GPC analysis was carried out in hexafluoroisopropanol as mobile phase with polymethyl methacrylate as standard, using a refractometer as detector.

The amine number was determined in accordance with DIN 13717. The OH numbers were determined in accordance with DIN 53240, part 2.

TABLE 1
Analytical data for the hyperbranched polyurea

| | Mₙ | M_{w} | Amine number [g of N/100 g of polymer] |
|---|---|---|---|
| Example | [g · mol⁻¹] | [g · mol⁻¹] | primary/secondary/tertiary/total |
| Polymer 1a | 3900 | 8400 | 7.7/1.3/6.2/15.2 |

Synthesis of a Propoxylate of Polymer 1a (Polymer 1)

The polymer 1a was then alkoxylated with an average of 5 propylene oxide units per NH group.

The highly branched polymer 1a (449.5 g, Mₙ=3900 g/mol, primary amines=7.7 g/100 g, secondary amines=1.3 g/100 g) was used as initial charge in a reactor, and inertized three times with nitrogen. The reactor was then heated to 50° C. and a pressure test was carried out. The mixture was dried for 1.5 h at 50° C. under a vacuum of <20 mbar. It was then heated to 100° C., and propylene oxide was added (350.4 g, corresponding to 0.5 mol of PO/NH group). Once all of the propylene oxide had been consumed by reaction, the reaction temperature was maintained until the pressure was constant. 29.9 g of a 50% strength potassium hydroxide solution were then added. The reaction mixture was dried again overnight at full vacuum (<20 mbar), in order to remove the water produced during the neutralization process. The next morning, a further 4.5 mol of PO/NH group (1569.7 g of PO) were added. The reaction temperature was increased up to 110° C. Once the addition phase had concluded, the mixture was kept at constant temperature to complete its reaction. The remaining propylene oxide was then removed by stripping under full vacuum (<20 mbar), and the reaction mixture was discharged, and the product was characterized by analysis.

TABLE 2
Analytical data for the hyperbranched polyurea

| | Viscosity at 25° C. | Hydroxy number |
|---|---|---|
| Example | [mPas] | [mg of KOH/g of polymer] |
| Polymer 1 | 4360 | 65 |

### INVENTIVE EXAMPLE 2

Synthesis of a Hyperbranched Polyurea Comprising Amino Groups, Urea Groups, and Ether Groups (Polymer 2a)

1 equivalent of urea and 1 equivalent of PolyTHF® Amin 350 (BASF SE) were used as initial charge at room temperature in a round-bottomed flask of appropriate size, equipped with a stirrer, reflux condenser, internal thermometer, and gas-outlet tube, and were heated to about 130° C., with stirring. Ammonia produced here was introduced by way of the gas-outlet tube and a gas-input frit into a washer using aqueous hydrochloric acid solution (c_{HCl}=30% by weight) to which a few drops of bromophenol blue had been admixed. The amount of hydrochloric acid in the washer had been calculated in advance in such a way that at neutralization it corresponded to 60 mol % conversion, based on the amount of ammonia that would be formed. The reaction mixture was then stirred at 130° C. until a change was discerned in the color of the indicator in the washer, due to neutralization of the hydrochloric acid by the ammonia produced through the reaction. The product was then cooled and analyzed.

GPC analysis was carried out in hexafluoroisopropanol as mobile phase with polymethyl methacrylate as standard, using a refractometer as detector.

The amine number was determined in accordance with DIN 13717.

TABLE 3
Analytical data for the hyperbranched polyurea

| | Mₙ | M_{w} | Amine number [g of N/100 g of polymer] |
|---|---|---|---|
| Ex. | [g · mol⁻¹] | [g · mol⁻¹] | primary/secondary/tertiary/total |
| Polymer 2a | 2950 | 9330 | 0.9/2.2/0.1/3.3 |

Synthesis of a Propoxylate of Polymer 2a (Polymer 2)

203.9 g of polymer 2a were weighed into a 400 mL autoclave together with 3.12 g of a 48% strength aqueous potassium hydroxide solution. The reaction mixture was heated to 110° C., with constant stirring, and inertized three times with nitrogen. The water from the KOH solution, and also the resultant water of reaction, were then removed in vacuo (<20 mbar) at 110° C. for 60 minutes. Once drying was complete, addition of propylene oxide was begun. The total amount of propylene oxide added to the reaction mixture was 108.23 g within a period of 90 minutes. Completion of monomer addition was followed by a period for completion of reaction of about 10 hours, until the pressure was constant. The system was then evacuated for 30 minutes in order to remove propylene oxide not consumed in the reaction, and the product was discharged at room temperature. 5% of Makrosorb™ and 2% of water were admixed with the alkaline crude product, for neutralization and after removal of the water (<20 bar) the mixture was finally filtered and then analyzed. The properties of the propoxylated polymer 2a were as follows:

Hydroxy number determined in accordance with DIN 53240: 185.2 mg of KOH/g

Amine number determined in accordance with DIN 13717: <0.1 g of prim. N/100 g; <0.1 g of sec. N/100 g; 2.5 g of tert. N/100 g.

### INVENTIVE EXAMPLE 3

Synthesis of a Hyperbranched Polyurea Comprising Amino Groups, Urea Groups, Carbamate Groups, and Ether Groups (Polymer 3a):

1 equivalent of diethyl carbonate, 1 equivalent of PolyTHF® Amin 350 (BASF SE), and KOH as catalyst (300 ppm, based on the entire composition) were used as initial charge at room temperature in a round-bottomed flask of appropriate size, equipped with a stirrer, reflux condenser, and internal thermometer, and were heated to about 150° C., with stirring. The boiling point of the gas phase reduced to about 120° C. during the course of the reaction, because of formation of ethanol as cleavage product. The apparatus was then provided with an inclined condenser and a distillation receiver, instead of the reflux condenser, and the condensate produced through the reaction was removed by distillation. Once the distillation process had ended, the pressure was reduced to 8 mbar, and the product was freed from volatile constituents. The system was then cooled to room temperature and the resultant polymer was analyzed.

GPC analysis was carried out in hexafluoroisopropanol as mobile phase with polymethyl methacrylate as standard, using a refractometer as detector.

The amine number was determined in accordance with DIN 13717.

TABLE 4
Analytical data for the hyperbranched polyurea

| | Mₙ | M_{w} | Amine number [g of N/100 g of polymer] |
|---|---|---|---|
| Ex. | [g · mol⁻¹] | [g · mol⁻¹] | primary/secondary/tertiary/total |
| Polymer 3a | 9500 | 14 600 | 1.4/2.4/0.2/4.3 |

Synthesis of a Propoxylate of Polymer 3a (Polymer 3)

223.59 g of polymer 3a were weighed into a 400 mL autoclave together with 3.78 g of a 48% strength aqueous potassium hydroxide solution. The reaction mixture was heated to 110° C., with constant stirring, and inertized three times with nitrogen. The water from the KOH solution, and also the resultant water of reaction, were then removed in vacuo (<20 mbar) at 110° C. for 60 minutes. Once drying was complete, addition of propylene oxide was begun. The total amount of propylene oxide added to the reaction mixture was 154.28 g within a period of 90 minutes. Completion of monomer addition was followed by a period for completion of reaction of about 10 hours, until the pressure was constant. The system was then evacuated for 30 minutes in order to remove propylene oxide not consumed in the reaction, and the product was discharged at room temperature. 5% of Makrosorb™ and 2% of water were admixed with the alkaline crude product, for neutralization and after removal of the water (<20 bar) the mixture was finally filtered and then analyzed. The properties of the propoxylated polymer 3a were as follows:

Hydroxy number determined in accordance with DIN 53240: 164.4 mg of KOH/g

Amine number determined in accordance with DIN 13717: 0.1 g of prim. N/100 g; 0.3 g of sec. N/100 g; 2.3 g of tert. N/100 g.

### INVENTIVE EXAMPLE 4

Synthesis of a Hyperbranched Polyurea Comprising Amino Groups, Urea Groups, and Carbamate Groups (Polymer 4):

1 equivalent of diethyl carbonate and 1 equivalent of tris(2-aminoethyl)amine (TAEA) were used as initial charge at room temperature in a round-bottomed flask of appropriate size, equipped with a stirrer, reflux condenser, and internal thermometer, and heated to about 130° C., with stirring. During the course of the reaction the boiling point of the gas phase decreased to about 100° C. because of formation of ethanol as cleavage product. The apparatus was then equipped with an inclined condenser and a distillation receiver, replacing the reflux condenser, and the condensate produced in the reaction was removed by distillation. Once the distillation process had ended, the pressure was reduced to 8mbar and the product was freed from volatile constituents. The system was then cooled to room temperature and the resultant polymer was analyzed.

GPC analysis was carried out in hexafluoroisopropanol as mobile phase with polymethyl methacrylate as standard. A refractometer was used as detector.

TABLE 5
Analytical data for the hyperbranched polyurea:

| | Mₙ | M_{w} |
|---|---|---|
| Example | [g · mol⁻¹] | [g · mol⁻¹] |
| Polymer 4 | 2800 | 6700 |

### INVENTIVE EXAMPLE 5

Synthesis of a Hyperbranched Polyamide (Polylysine, Polymer 5)

1000 g of L-lysine hydrochloride, 218 g of sodium hydroxide, 100 g of water, and 0.3 g of dibutyltin dilaurate were placed in a 4 L four-necked flask equipped with stirrer, internal thermometer, gas-inlet tube, and inclined condenser with vacuum connection and receiver, and the mixture was heated to an internal temperature of 150° C., with stirring. After a reaction time of 5 hours, water was removed by distillation at reduced pressure (200 mbar), and once most of the water had passed over here the temperature was slowly increased to 180° C. and the pressure was reduced to 10 mbar. After 8 hours, 240 g of water had been collected as distillate. The highly viscous polymer was discharged while hot, poured onto a metal sheet for cooling, and then ground to small dimensions in a mortar. To determine molecular-weight distribution, the product was dissolved in water to give a 50% by weight solution. The aqueous solution was then filtered and subjected to GPC. GPC analysis used a column combination of OHpak SB-803 HQ and SB-804 HQ (Shodex) in aqueous solution, with addition of 0.1 mol/L of sodium hydrogencarbonate at 30° C., using a flow rate of 0.5 mL/min with polyethylene oxide as standard. A UV detector was used, operating at a wavelength of 230 nm.

TABLE 6
Analytical data for the hyperbranched polylysine:

| | Mₙ | M_{w} |
|---|---|---|
| Example | [g · mol⁻¹] | [g · mol⁻¹] |
| Polymer 5 | 2330 | 11 050 |

### INVENTIVE EXAMPLE 6

Synthesis of a Nitrogen-Containing Polymer Based on tris(hydroxyethyl)isocyanurate THEIC (Polymer 6)

783 g of THEIC, 225 g of distilled water, and 3.0 g of sulfuric acid (from 93 to 95% strength) were used as initial charge in a 2 L four-necked flask equipped with stirrer, distillation bridge with vacuum connection, gas-inlet tube, and internal thermometer, and the mixture was heated to 80° C. under a gentle stream of nitrogen, and stirred at this temperature for 1 h. The temperature was then increased to from 120 to 130° C., and water was removed by way of the distillation bridge. After 1 h, the temperature of the mixture was increased to 150° C., the pressure was lowered to 100 mbar, and the mixture was allowed to continue reaction at this temperature. After 40 min., the reaction mixture exhibited a marked rise in viscosity. The reaction was terminated by using 50% strength aqueous NaOH solution to adjust the pH of the mixture to 7. The reaction mixture was then cooled to room temperature and analyzed.

The product of the invention was analyzed by gel permeation chromatography, using a refractometer as detector. Dimethylacetamide (DMAc) was used as mobile phase, and polymethyl methacrylate (PMMA) was used as standard for determining molecular weight.

Glass transition temperature (T_{g}) was determined by DSC, using a heating rate of 5° C./min., and evaluating the second heating curve.

OH number was determined in accordance with DIN 53240, part 2.

TABLE 7
Analytical data for polymer 6

| | T_{g} | Mₙ | M_{w} | Hydroxy number [mg of |
|---|---|---|---|---|
| Example | [° C.] | [g · mol⁻¹] | [g · mol⁻¹] | KOH/g of polymer] |
| Polymer 6 | 55 | 1910 | 13 000 | 330 |

In order to use the polymer of the invention in the PU system, 500 g of a polyethylene glycol with an average molar mass of 200 g/mol (Pluriol® E200, BASF SE) were admixed with 500 g of the polymer, and the mixture was slowly heated to 120° C., and stirred until the THEIC polymer had dissolved completely. The solution, still hot, was discharged through a water-resistant cotton-textile filter (400 μm) and cooled.

The OH number of the solution was 446 mg of KOH/g of polymer.

### INVENTIVE EXAMPLES 7 TO 9 AND COMPARATIVE EXAMPLE

Use of hyperbranched polyurea polyols in flame-retardant flexible foams

Starting Materials:
Polyol 1: Graft polyol based on styrene-acrylonitrile with 45% solids content in a polyoxypropylene polyoxyethylene polyol with OH number 20 mg of KOH/g and with average functionality 2.7
Polyol 2: Polyoxypropylene polyoxyethylene polyol with OH number 35 mg of KOH/g and with average functionality 2.7
Polyol 3: hyperbranched polyol made of urea, trisaminopropylamine, and propylene oxide, produced as in inventive example 1 (polymer 1) with OH number 75 mg of KOH/g
Polyol 4: hyperbranched polyol made of urea, trisaminoethylamine and propylene oxide (polymer 4) with OH number 269 mg of KOH/g
Catalyst system 1: Mixture made of Dabco 33 LV, Lupragen N206, and Kosmos 29
Catalyst system 2: formic-acid-capped amine catalysts
Isocyanate 1: Tolylene diisocyanate, NCO content: 48.3% by weight

TABLE 8
Constitution of flexible foam formulations and results of
flame-retardancy tests

| | | Comparative | Inventive | Inventive | Inventive |
|---|---|---|---|---|---|
| Formulation | | example 1 | example 7 | example 8 | example 9 |
| Polyol 1 | pw | 33.3 | 33.3 | 33.3 | 33.3 |
| Polyol 2 | pw | 66.7 | 66.7 | 66.7 | 66.7 |
| Diethanolamine | pw | 1.49 | 1.49 | 1.49 | 1.49 |
| Polyol 3 | pw | — | 10 | 10 | |
| Polyol 4 | pw | — | — | — | 12 |
| Water | pw | 1.90 | 1.63 | 2.10 | 2.7 |
| Stabilizer | pw | 0.5 | 0.5 | 0.6 | 0.5 |
| Catalyst | pw | 0.42 | 0.30 | 0.40 | |
| system 1 | | | | | |
| Catalyst | pw | | | | 0.30 |
| system 2 | | | | | |
| Isocyanate 1 | | | | | |
| | Index | 107 | 107 | 107 | 107 |
| Properties | | | | | |
| Envelope | kg/m³ | 37.2 | 47.8 | 38.3 | 36.6 |
| density, core | | | | | |
| Compressive | kPa | 3.8 | 6.1 | 5.0 | 4.6 |
| strength, 40% | | | | | |
| Flame- | | | | | |
| retardancy | | | | | |
| test | | | | | |
| Average | mm | 262 | 100 | 126 | 117 |
| carbonized | | | | | |
| length | | | | | |
| Max. | mm | 306 | 110 | 140 | 144 |
| carbonized | | | | | |
| length | | | | | |
| Average | s | 29 | 0 | 2 | 1 |
| afterflame time | | | | | |
| Max. afterflame | s | 42 | 0 | 8 | 3 |
| time | | failed | passed | passed | passed |

The methods used to determine the properties were as follows:
Envelope density in kg/m³: DIN EN ISO 845
Compressive strength in kPa: DIN EN ISO 3386
Flame retardancy: California 117 TB

Inventive Examples 7 to 9 and comparative example 1 show that the foam without hyperbranched polyurea fails the flame test, whereas the foams of inventive examples 7 to 9 pass the test.

### INVENTIVE EXAMPLE 10 AND COMPARATIVE EXAMPLE 2

Use of Hyperbranched Polylysine in Flame-Retardant Flexible Foams

Starting Materials:
Polyol 1: Graft polyol based on styrene-acrylonitrile with 45% solids content in a polyoxypropylene polyoxyethylene polyol with OH number 20 mg of KOH/g and with average functionality 2.7
Polyol 2: Polyoxypropylene polyoxyethylene polyol with OH number 35 mg of KOH/g and with average functionality 2.7
Polymer 5: hyperbranched polylysine produced as in inventive example 5
Catalyst: Mixture made of Dabco 33 LV, Lupragen N206, and Kosmos 29
Isocyanate 1: Tolylene diisocyanate, NCO content 48.3% by weight

TABLE 9
Constitution of flexible foam formulations and results of
flame-retardancy tests

| | | Comparative | Inventive |
|---|---|---|---|
| Formulation | | example 2 | example 10 |
| Polyol 1 | pw | 33.3 | 33.3 |
| Polyol 2 | pw | 66.7 | 66.7 |
| Diethanolamine | pw | 1.49 | 1.49 |
| Polymer 5 | pw | — | 10 |
| Water | pw | 1.63 | 1.63 |
| Stabilizer | pw | 0.5 | 0.5 |
| Catalyst system 1 | pw | 0.42 | 0.55 |
| Isocyanate 1 | | | |
| | Index | 107 | 107 |
| Properties | | | |
| Envelope density, core | kg/m³ | 37.2 | 33.7 |
| Compressive strength, 40% | kPa | 3.8 | 6.2 |
| Flame-retardancy test | | | |
| Average carbonized length | mm | 262 | 122 |
| Max. carbonized length | mm | 306 | 8 |
| Average afterflame time | s | 29 | 0 |
| Max. afterflame time | s | 42 | 2 |
| | | failed | passed |

The methods used to determine the properties were as follows:
Envelope density in kg/m³: DIN EN ISO 845
Compressive strength in kPa: DIN EN ISO 3386
Flame retardancy: California 117 TB

Inventive example 10 and comparative example 2 show that the foam with the hyperbranched polylysine passes the flame test at a significantly lower density, whereas the comparative foam fails to meet the requirements.

### INVENTIVE EXAMPLE 11 AND COMPARATIVE EXAMPLE 3

Use of Hyperbranched Polyisocyanurate in Flame-Retardant Flexible Foams

Starting Materials:
Polyol 1: Graft polyol based on styrene-acrylonitrile with 45% solids content in a polyoxypropylene polyoxyethylene polyol with OH number 20 mg of KOH/g and with average functionality 2.7
Polyol 2: Polyoxypropylene polyoxyethylene polyol with OH number 35 mg of KOH/g and with average functionality 2.7
Polymer 6: hyperbranched tris(2-hydroxyethyl) isocyanurate, produced as in inventive example 6; 50% strength solution in polyethylene glycol with OH number 446 mg of KOH/g
Catalyst: Mixture made of Dabco 33 LV, Lupragen N206, and Kosmos 29
Isocyanate 1: Tolylene diisocyanate, NCO content 48.3% by weight

TABLE 10
Constitution of flexible foam formulations and results of
flame-retardancy tests

| | Comparative | Inventive | |
|---|---|---|---|
| Formulation | example 3 | example 11 | |
| Polyol 1 | pw | 33.3 | 33.3 |
| Polyol 2 | pw | 66.7 | 66.7 |
| Diethanolamine | pw | 1.49 | 1.49 |
| Polymer 6 | pw | — | 10.0 |
| Water | pw | 1.90 | 2.00 |
| Stabilizer | pw | 0.50 | 0.50 |
| Catalyst | pw | 0.42 | 0.40 |
| Isocyanate 1 | | | |
| | Index | 107 | 107 |
| Properties | | | |
| Envelope density, core | kg/m³ | 37.2 | 34.8 |
| Compressive strength, 40% | kPa | 3.8 | 3.3 |
| Flame-retardancy test | | | |
| Average carbonized length | mm | 262 | 140 |
| Max. carbonized length | mm | 306 | 156 |
| Average afterflame time | s | 29 | 0 |
| Max. afterflame time | s | 42 | 0 |
| | | failed | passed |

The methods used to determine the properties were as follows:
Envelope density in kg/m³: DIN EN ISO 845
Compressive strength in kPa: DIN EN ISO 3386
Flame retardancy: California 117 TB

Inventive example 11 and comparative example 3 show that the foam with the hyperbranched Poly(THEIC) passes the flame test at significantly lower density, whereas the comparative foam fails said test.

### INVENTIVE EXAMPLE 12 AND COMPARATIVE EXAMPLES 4 AND 5

Catalyst system 1: Mixture made of Dabco 33 LV, Lupragen N206, and Kosmos 29
Catalyst system 2: formic-acid-capped amine catalysts

TABLE 11
Constitution of flexible foam formulations and results of
flame-retardancy tests

| | | Comparative | Comparative | Comparative | Inventive |
|---|---|---|---|---|---|
| Formulation | | example 3 | example 4 | example 5 | example 12 |
| Polyol 1 | pw | 33.3 | 20.0 | 20.0 | 20.0 |
| Polyol 2 | pw | 66.7 | 80.0 | 80.0 | 80.0 |
| Polymer 4 | pw | — | — | — | 12.0 |
| Urea | pw | — | 5.0 | — | — |
| Dimethylurea | pw | — | — | 12.0 | — |
| Water | pw | 1.90 | 2.3 | 2.7 | 2.70 |
| Stabilizer | pw | 0.50 | 0.50 | 0.50 | 0.50 |
| Catalyst system 1 | pw | 0.42 | — | — | — |
| Catalyst system 2 | pw | — | 0.30 | 0.30 | 0.25 |
| Isocyanate 1 | | | | | |
| | Index | 107 | 107 | 107 | 107 |
| Foaming | | | | | |
| Cream time | s | 12 | 8 | 9 | 10 |
| Gel time | s | 72 | — | 58 | 62 |
| Properties | | | | | |
| Envelope density, core | kg/m³ | 37.2 | 37.4 | 37.6 | 36.6 |
| Compressive strength, | kPa | 3.8 | 1.8 | 1.2 | 4.6 |
| 40% | | | | | |
| Tensile strength | kPa | 130 | 60 | 137 | 109 |
| Flame-retardancy test | | | | | |
| Average carbonized | mm | 262 | 153 | 167 | 117 |
| length | | | | | |
| Max. carbonized length | mm | 306 | 168 | 192 | 144 |
| Average afterflame | s | 29 | 0 | 0 | 1 |
| time | | | | | |
| Max. afterflame time | s | 42 | 0 | 0 | 3 |
| | | failed | failed | failed | passed |

* as in inventive example 4

The methods used to determine the properties were as follows:
Envelope density in kg/m³: DIN EN ISO 845
Compressive strength in kPa: DIN EN ISO 3386
Tensile strength in kPa: DIN EN ISO 1798
Flame retardancy test: California 117 TB

As can be seen from the examples, urea and dimethylurea have a disadvantageous effect on the processing of the foams and on their mechanical properties. They are low-molecular-weight additives that adversely affect not only hardness but also the tensile strength of the foams. The polyfunctional polyureas have no, or significantly less, effect on hardness and tensile strength. Use of more than 5 parts of urea leads to even poorer mechanical properties and to undissolved urea particles within the foam.

All of the foams were produced with an acid-capped amine catalyst. The process parameters (cream time, gel time, and fiber time) are nevertheless poorer in the comparative examples. In the case of both low-molecular-weight additives, the cream times are very short, despite use of a capped catalyst. In the case of urea, no gel time can be determined, since the foam remains tacky over a long period.

1. A process for producing polyurethane foams, by mixing (a) polyisocyanates with (b) at least one relatively high-molecular-weight compound having at least two reactive hydrogen atoms, (c) at least one nitrogen-containing hyperbranched polymer having at least 2% by weight nitrogen content, (d) optionally low-molecular-weight chain extenders and/or crosslinking agents, (e) catalysts, (f) blowing agents, and (g) optionally other additives, to give a reaction mixture, and hardening to give the polyurethane foam.

2. The process according to claim 1, wherein the nitrogen-containing hyperbranched polymers (c) have been selected from the group consisting of hyperbranched polyureas, hyperbranched polyamides, hyperbranched polyesteramides, hyperbranched polyisocyanurates, and hyperbranched polyesteramines.

3. The process according to claim 1, wherein the nitrogen content of the nitrogen-containing hyperbranched polymers is from 3 to 75% by weight.

4. The process according to claim 1, wherein nitrogen-containing hyperbranched polymers used comprise hyperbranched polyureas which are obtainable via reaction of one or more ureas or of one or more carbonates with one or more amines having at least two primary and/or secondary amino groups, where at least one amine has three primary and/or secondary amino groups.

5. The process according to claim 1, wherein a hyperbranched polyisocyanurate is used as nitrogen-containing polymer.

6. The process according to claim 5, wherein a hyperbranched polyisocyanurate based on tris(hydroxyethyl)isocyanurate is used.

7. The process according to claim 1, wherein a hyperbranched polylysine is used as nitrogen-containing polymer.

8. The process according to claim 1, wherein amounts used of nitrogen-containing hyperbranched polymers are from 1 to 50% by weight, based on all of components (a) to (g) of the reaction mixture.

9. A polyurethane foam obtainable by the process according to claim 1.

10. The polyurethane foam according to claim 9, comprising from 1 to 8% by weight of nitrogen from the hyperbranched polymer (c).
